(19) United States
(12) Patent Application Publication
(10) Pub. No.: US 2018/0180034 A1
(43) Pub. Date: Jun. 28, 2018

(54) Osmosis energy storage & restoration system and indirect solar powerplant

(71) Applicant: Yanming Wei, Mountain (CA)

(72) Inventor: Yanming Wei, Mountain (CA)

(21) Appl. No.: 15/902,651

(22) Filed: Feb. 22, 2018

(51) Int. Cl. F03G 7/00; B01D 61/00; B01D 61/02; B01D 69/10; B01D 71/50; C02F 1/44

(52) U.S. Cl. CPC F03G 7/005; B01D 61/002; B01D 61/022; C02F 2103/08; B01D 71/50; C02F 1/445; C02F 1/441; B01D 69/10

(57) ABSTRACT

Natural water evaporation is a buffered process with huge energy absorption from solar & its derivative wind energy. When large surface shallow pool filled with aqueous solution is exposed under sky, the most portion of natural energy will be spent for pulling water out of water molecules cluster, yet there is still some energy for splitting water from solutes, then the concentration increases, in turn, despite the main former energy is sacrificed, but the stronger solution can redeem most the latter energy during a process of Pressure Retarded Osmosis (PRO), via membranes separating solution & available water in situ, then the redeemed energy serves as utilizable power output, with the assistance of key units or components: the osmotic to hydraulic pressure transformer, the hydraulic oil current rectification fluidic circuit & a hydraulic motor. With minor adaptation, same mechanism can also be embodied as: mobile osmosis engine, osmosis vehicle battery, yard synergy-osmosis power system, Grid electricity and miscellaneous renewable energy to osmosis energy storage, even desert to oasis remediation with seawater intake solar-via-osmosis powerplant & parasitic freshwater factory.

### THE SCIENCE BEHIND SUBJECT INVENTIONS AND PRIOR ARTS

### 1. Osmosis Pressure & Energy Density

The natural process known as osmosis was first discovered as early as back in 1748 by Jean-Antoine Nollet. Another one century later, in 1885, the first winner of the Nobel Prize in Chemistry, Jacobs Henricus Van't Hoff contributed the osmotic pressure equation that is similar with the colligative gas state equation: π=iMRT,

where π is osmotic pressure, i—ion factor, M—concentration in molarity (moles per liter), R—gas constant, T—temperature.

As an example, for the regular sea water, at normal temperature, its osmotic pressure equals to 2*0.55*0.0821*300=27 atmospheric pressure. This significant pressure means that the river water can pump sea water 270 meter high by natural osmosis!

As to the energy density, just first exam the equivalence of pressure dimension: Pascal=Newtons per square meter=N/m²=NM/m³=J/m³=Joules per cubic meter. Therefore, the pressure itself does imply volumetric energy density. For easy understanding, as a preference, Joule is less used, but Kiwaho, i.e. kilowatt-hour prevails, aka 1000*3600=3.6 MJ.

For extreme osmotic pressure exploitation, saturated solution is always preferred. As the sea water concentration is only about 10% of its saturated state, therefore, the max energy density of sodium chloride solution could be 27*10=270 atm, i.e. 27 MPa (million pascals), equivalent to 27 MJ/m³, or 7.5 kiwaho per cubic meter. Here the kiwaho is a new energy unit coined by me: 1 kiwaho==1 kwh=1000 wh=1 kilowatts hour=3.6*10⁶ joules.

It is necessary to note that Van't Hoff equation is accurate only for very dilute solution, and late generations of scientists have found that the osmotic pressure of saturated solution can be measured to a significant larger readout at about double of calculated value from original equation. Many recent science papers fit out new equations for thick up to saturated solution.

Therefore, the afore-estimated osmotic pressure for saturated salt solution should be corrected from 270 atm to 540 atm, or energy density 54 MJ/m³.

Even a mild raise of ambient temperature can further contribute increment up to 50% more onto the osmotic pressure.

Not only inorganic solution, i.e. electrolytic solution, can generate osmotic pressure, but also organic solution can do, such as sugar solution.

### 2. Status Quo of Membrane Technologies

Osmosis application is greatly dependent on the maturity degree of membranes.

Nowadays, the price and quality of water semi-permeable membranes loom rosy. Especially, the water purification demand is advancing steadily membrane technology development.

With market availability, the industry of osmosis energy utility is already at the starting line, and just need to improve prior technologies and overcome all relevant engineering problems.

3. What does the Pressure Retarded Osmosis (PRO) Technology Suffer From?

This method of generating power was invented by Professor Sidney Loeb in 1973 at the Ben-Gurion University of the Negev, Beersheba, Israel.

The world first osmotic plant with capacity of 4 kW was opened by Statkraft on Nov. 24 , 2009 in Tofte of Norway. In January 2014, Statkraft terminated their osmosis project, because of many difficulties for scale-up, such as expensive membranes, silt and bacteria clog or contamination, cheaper competition from other renewable energy source, etc.

From the point of engineering, high pressure energy should be harvested by high efficient conventional hydraulic motor, and the best working fluid is the commercial engineered hydraulic mineral oil with proper viscosity, anti-corrosion and temperature stability.

The carrier of osmotic pressure is usually aqueous solution, of course, it is never decent choice to directly drive a hydraulic motor designed for special oil, though pressure is matchable, unless a special adapting mechanism can be invented to translate osmotic power into hydraulic power, but serious challenges must be coped fair in seal, corrosion prevention and maintenance.

### BACKGROUND, TRIAL CALCULATION, INSPIRATION & GENERAL ADVICES

This invention is intended to present systematical integration methods for renewable energy development contractors or equipment manufacturers or even those enthusiastic DlYers, to facilitate their projects and products of indirect solar energy harvest by taking advantage of natural water circulation with both energy absorption and release.

Of which, the key is how to utilize the released energy from the osmosis process, as well as the other 2 processes of the full loop are well managed by the Great Nature's atmosphere “heat engine”: evaporation and precipitation, so as not to use water as a consuming material in the sustainable energy system.

In this cycle, not only such evaporation is a process of solely evaporation, but also process of RO (Reverse Osmosis) as the second effect, and precipitation looks like feedback process.

In prior arts, the role of this invention is played by solar chimney i.e. solar updraft tower or thermodynamic process that may involve low grade heat source oriented application, such as waste heat driven Rankine heat engine.

Unfortunately both the traditional solar chimney and heat engine are so low efficient for low grade heat source and very expensive for waste heat recovery. For example, a solar updraft tower built in Spain since 1982 occupies 110 acres land with 50 kw max power, it means the energy density only tiny 0.11 w/m² and efficiency 0.01%. Further, if a special heat engine is used, matching the low temperature phase change between liquid & gas, has to use some eco-unfriendly refrigerants as working media.

The osmosis phenomenon is caused by the potentiality of concentration differentiate across semi-permeable membrane, and converting the potentiality into useful energy needs neither phase change nor high temperature, yet with decent efficiency and great energy density, because it is a quasi chemical energy that is not capped by the humble Carnot cycle efficiency.

By retarding osmosis, energy can be harvested. With mature theory, a varying load of energy consumer can retard osmosis process at an even predictable pattern, but if over-retarded to the max limit, osmosis will stop immediately until the load attenuates under limit.

Disappointed with the technology & commercialization progress, though the Pressure Retarded Osmosis (PRO) method has been invented for almost half of a century, now I am motivated and inspired by the great maturity of membrane technology and the omnipresent hydraulic power application, it is the high time to invent new feasible methods for resurgence of antique PRO technology with popular hydraulic elements.

In my humble opinion, the failed commercialization of the prior PRO method shall not be imputed only to expensive membrane or easy clog or whatever else, but also the infeasible regular hydrodynamic turbine, because osmotic pressure is far greater than regular water head pressure in common hydropower stations, but the max affordable flow rate of any membrane assembly is so humbly far less than the theorized limit.

In fact, the max feasible osmotic pressure can be as high as 500 atmosphere pressure, and that means it reasonably falls in the pressure range of any commercial hydraulic power system, such as excavators, cranes, forklifts, etc.

According to hydraulic power equation: Power=Pressure×FlowRate, it shows that: for same power, the higher the pressure, the lower the flow rate, thus the flow rate or flux in hydraulic system is far less by many orders of magnitude than regular hydrodynamic water flux.

By taking advantage of high osmotic pressure, the expensive membrane area demand will be greatly reduced, this will save big capital investment, and make osmosis energy generation more compact & competitive than other renewable energy.

Analogy is a powerful approach to quickly characterize a new object by applying knowledge of ready familiar object in other field. Osmosis flow rate is analogous with electric current I, membrane with resistor R, and pressure with voltage V, thus even electronic equation can inspire the same: the power cable in vehicle 12V system is always thicker & heavier & expensive by an order of magnitude than indoor 120V system! That is why the long distance hydro-pole transmission always uses extreme high voltage; and power=I*V=I²*R=V²/R, that is why osmosis power will be quadrupled if pressure doubled.

Such an exponential increase will bring huge increase on the average areal power density of membranes: e.g. the ready recognized max 10 W/m² for seawater versus freshwater PRO membrane will be increased to circa 4000 watts per square meter membranes if it is used in a saturated salt solution versus freshwater PRO system, because the osmotic pressure is increased by 20 times. In economics, such high pressure application can save about 400 times on membranes cost!

The seawater's osmotic pressure is about 27 atm, such a mediocre pressure is embarrassing for the hydraulic application, though amplifying to proper pressure by lever mechanism is not difficult, and hence, using subject invention to scavenge osmosis energy may not be economic enough, unless someday in future membranes cost could become dirty cheap.

The key inspiration is that: why not boldly to devise a conversion interface between aqueous solution power and hydraulic oil power? With this interface, the expensive hydraulic motor can be protected and work in best performance and there is no worry of expensive oil leakage because of mature technology & workmanship of seal material for hydraulic oil with proper viscosity & rheological characteristics; in aqueous side, despite corrosion and leakage both are unavoidable, but anyway there are no expensive parts and periodic change of consuming parts is just easy job or small deal, even minor leakage is tolerant though ugly, because water and solute are both quite cheap even free.

Anyway, salt is so cheap that everyone is affordable to stock a decent pile or concoct large volume saturated salt solution that is 10 times stronger than seawater on own backyard, therefore, nobody has to live seaside for hydraulically harvesting energy from natural osmosis process, as long as the salt in the energy system is conservative, unlike the consuming salt in a regular water softener.

Luckily, in this innovative system, the salt usage is just conservative (just like the conservation of working medium in other thermodynamic system), because evaporation can only bring away water, not salt molecules, even icing can only act on water, that is why an iceberg floating on salty ocean is simply pure freshwater.

To get self-sufficient energy from the natural water circulation, users have to offer large enough area land, because the harvestable energy is proportional to land size. Following calculation can guide users to plan osmosis energy project:

Meteorology statistic data assert that the global average precipitation is about 1000 millimeters per year, i.e. the average precipitating rate=1000/365/24/3600=3.17*10⁻⁸ m/s=32 nm/s.

In equilibrium, the evaporation should be the same with precipitation every year, i.e. the global average evaporating rate is also about 32 nanometer per second, and it is equivalent to average energy absorption 77 W/m² (watts per square meter), as per thermology derivation.

On project site, a large size solution pool can enable evaporation fast, for convenience, just reasonably assume 50 nm/s. As per thermology, given water density 1000 kg/m³, evaporation enthalpy at room temperature 2400 kj/kg, the absorbed power for average evaporation rate is 5*10⁻⁵*2400=0.12 kj/s/m²=120 W/m². Note: this energy density is not provided only by solar energy which ground density at noon is circa 1000 W/m², but also by random wind energy. Because most solar energy is reflected back to sky and consumed to increase water body temperature, that is why only circa (77˜120)/1000=8%˜12% is consumed on evaporation.

For sustainability & good practice, the drawn water flux from underground water table to dilute saturated salt solution via osmosis, should theoretically equal evaporation rate in situ.

Assuming users energy demand is 1000 kiwaho per month, i.e. 1000/30=33 kiwaho/day, then the power should be 33/24=1.4 kw, it is also the desired power from osmosis engine.

Given osmotic pressure of the saturated salt solution is 54 MPa, then the input freshwater flux rate=Power/Pressure=1400/54000000=2.6*10⁻⁵ m³/s=26 cc/s=26 ml/s (milliliter/second), obviously, such a flow rate does not need too much membrane area.

Supposedly hydraulic cylinders ram speed should be less than 25 cm/s, and the lesser the speed, the lower wearing as well as longer life expectation a cylinder will be. Given 26 ml/s, the minimal piston area is larger than 26/25>1 cm², apparently it is easy to enable pistons motion as slow 1 mm/s as injecting medicine via a syringe, yet still with thousands watts powerful output, provided the diameter >18 cm, thanks to the high pressure!

Nowadays membrane performance is improved year by year. For example, the market available forward osmosis membrane can easily reach 0.33 μm/s/atm. Even if its capped flow rate is a so-so 50 μm/s, then for the demanded 26 ml/s, the minimal membrane area is: 26/0.005=5200 cm²=0.52 m², and the areal power density of membranes is 1400/.52 =2692 W/m², and this result is reasonably under the max 4000 W/m² that is estimated in previous analogy analysis.

A regular cartridge of RO (Reverse Osmosis) membrane has 0.5 m² in wound spiral form, just equivalent to the above calculated value. Of course, it cannot be used in this PRO invention, because it can only withstand a dozen of atmosphere pressure, unless a reinforced structure design is implemented.

The required evaporation area is: FlowRate/EvaporationRate=2.6*10⁻⁵/5*10⁻⁸=520 m². Obviously, this land size is not affordable for all families unless living in rural district or suburban or willing to sacrifice some gardening area.

Subtotal evaporation from pool is 24*3600*(5*10⁻⁸*520)=2.25 m³/day=freshwater or quasi freshwater usage per day, and the volumetric energy density=33/2.25=14.7 kiwaho/m³=14.7 kwh/m³ or about 15 wh/kg, here either volume or weight is in regard to freshwater.

As to the total backlog water and salt, it depends on depth of pool, the deeper, the more water & salt. If depth=10 cm (centimeters), then total saturated salt solution volume is 520*0.1=52 m³; given density 1.2, then detail data can be figured: total weight=62.4 tons, salt=26.4%*62.4=16.5 tons, and water=46 tons.

Reducing backlog water & salt can save lots of initial investment, but for minimal impact on performance, a good practice should set the minimal depth of pool equivalent to about 10 days average evaporation, i.e. 3.17*10=3.2 cm, thus the aforementioned backlog calculation can be still reduced by 3 times more.

If not too care about unstable weather, even one days buffering is also considerable, then the shallowest depth can be 3.17*1<5 mm, and the bulk weight of salt can be greatly reduced to as low as 16.5/30=0.55 ton=550 kg, the solution weight=62.4/30=2.08 ton=2080 kg in pool. However for such 5 mm shallow pool, its levelness or floor grading should be very small, so as not to expose bottom then waste evaporation area at some zones.

In assumption of only one day buffering for the pool depth, there are two possible extreme conditions: If the weather is best and the osmosis engine is shutdown for maintenance, then in the second day, the pool will dry out and the white salt grains will be seen, hence, in order to restart the system in next day, it is a prerequisite to remake full qualified solution by pouring water into the dried pool; else if the weather is too bad and the osmosis engine works in full capacity, then in second day, the solution concentration will be cut half to 50% of first day, because zero evaporation will result in doubled water, and in turn, the real power in next day will be only 25% of the rated full power, because the osmotic pressure only 50% left, then only 25% power left, according to the analogous formula in electrics domain: Power=V²/R, here the osmotic pressure is analogous to the voltage.

Price comparison with photovoltaic (PV) system: currently PV panels cost about $3 USD per watt at end users, considering Earth surface area=4 times of the projection circular area under sunshine, thus 1 solar watt without sun-tracker is equivalent to 0.25 osmosis watt, then adjusted value: $12 USD/W for fair comparison, and 12*1400=$16800 for same capacity of osmosis power, before counting PV system integration cost. The PV reality even more grim: the nameplated wattage and efficiency are just the max possible, and experiments show that efficiency decreases at a rate of −0.5% per Celsius degree.

Using highway deicing salt can save big, because of its current price as cheap as $100/ton. For the 10 days buffering design, 16.5/3=5.5 tons salt costs only $550. Of course, it is bad idea to use table salt, because of cost soaring too much, though preparing solution is easier and faster. The key unit of osmotic-hydraulic energy conversion may be equivalent to the PV system integration cost, such as Sun tracking, inverter, etc. Therefore, the total cost is far less than PV.

Salts may not always be the king for this application, for example, a farming family can use own produce—the raw cane sugar as the working solute, and get equivalent osmosis energy in a cheaper way, without having to buy salt and pay logistic cost, because of too heavy.

Another 2 facts are also interesting. One is the low energy areal density: 1400/520=2.7 watts per square meter of evaporation pool, and the solar mean energy density on the rotating earth surface is 1360/4=340 W/m² on 24 hours, here number 1360 is the standard value measured by NASA space instruments, because daily sweep sphere surface area=4×projection circular area, thus, only 2.7/340=0.8% of solar energy is scavenged; another is the ratio of osmosis to evaporation energy 2.7/120=2.25%, it reflects efficiency of energy conversion. In case of bad weather, users may use accessible free waste heat for evaporation of the diluted exhaust solution in pool, and then the efficiency has to be considered.

The valid value 2.7 w/m² seems contemptible, but it does deserve a warmhearted appreciation after following trial calculation proves that even such a humble energy density will create 7 more times profit than cash crops:

As per the latest agriculture statistics report, one acre soybean can generate $653 USD per year, but if the same area land is used for the reliable and low capital cost osmosis power generation, it will output energy: 4047*2.7*24*365/1000=95720 kwh, given 1 acre=4047 m², and assuming electricity fair price $0.05/kwh, then total value=95720*0.05=$4786=7.3 times of the soybean income!

In fact, even the energy density as low as 2.7/7.3=0.37 w/m², it is still as profitable as plantation of cash crops. By the way, salute to farmers all over the world for their generosity of feeding cities with so cheap foods, because as least 45 w/m² is used by photosynthesis, but consumer only pays 0.37 w/m² at $0.05/kwh exploitively, what a 99% off discount!

As to the efficiency, why it is so low? The reason is that: to evaporate aqueous solution always spends more energy than to evaporate freshwater, and the afore-calculated 2.25% energy differentiate is just used for splitting water molecules from solute molecules that is equivalent to reverse osmosis. In a sense, during such evaporation, reverse osmosis process looks like a bridesmaid.

For high grade fuel, such as gasoline, conventional internal combustion engine can have about 30% efficiency from heat to power conversion, in contrast, the low grade waste heat or biomass may have humble efficiency from 2% to 10%.

Therefore, it is a bad idea to buy high grade fuel to heat the salt solution pool for evaporation unless it is for salt production. The conventional reverse osmosis is still the highest efficient method to overcome bad weather condition, as its efficiency is close to the ideal 100%. Most hydro companies set about 50% of regular price at nights and holidays, so as to balance loads between peak and valley time, of course, it is a good idea to use hydro grid power to do reverse osmosis during off-peak time and bad weather.

Because osmosis pressure is in linear relation with temperature, thus an osmosis engine can also partially function as a heat engine, the efficiency of such a heat engine can be calculated:

Heating 1 kg saturated solution consumes circa 3.2 kj heat per ΔT=1° C. increment that is 1/(273+20)=0.34% in room temperature, and as per previous estimation, its osmosis energy density 15 wh/kg, hence the increment of energy Δ=0.34%*15*3600=183 J, therefore heat engine efficiency η=183/3200=5.7%. Obviously the efficiency relies on concentration differential.

Also the heated solution renders high evaporation rate, in turn, it will increase the harvestable pond surface power density, especially in winter, the heated pond may show quasi lake effect.

Considering above 2 points, plus the heated solution can last for awhile of many osmosis cycles, therefore, using cheap even free biomass to heat salt pond can still a good choice to sustain osmosis powerplant in winter, or can be a boost method in regular seasons.

Despite the latent heat in low temperature water vapor is far greater than the concomitant osmosis energy, but at current technology level, it seems that its reclamation is the privilege of natural climate system, thus scavenging the osmosis energy is still appreciable by the natural water circulation, yet more economic, higher efficiency & land saving than a solar chimney.

Theoretically the water evaporation rate is proportional to (saturated pressure—real vapor pressure), and temperature. In real word, lots of factors in effect, even include wind velocity, so it is complicated very much to deduce an official formula. However there exist a few of empirical formulas.

For example, the EngineeringToolbox website proposes an empirical equation:

Gs=(25+19ν)A(Xs−X)/3600

Where ν is the wind speed, A is the water surface area, Xs is the theoretical mass proportion of water in saturated air; X is the real respective value.

Take an example to estimate evaporation rate from a pool:

Given temperature 25° C., the saturation humidity ratio is 0.02 kg/kg. If relative humidity is 50%, then the ratio of water to air is 0.01 kg/kg.

For a 25 m×20 m salt pool and a breeze of 0.5 m/s velocity above the surface, the evaporation amount can be calculated as:

Gs=(25+19 (0.5 m/s)) ((25 m) (20 m)) ((0.02 kg/kg)−(0.01 kg/kg))/3600=0.049 kg/s.

The evaporation rate in thickness change is about 0.049/((25*20)*1000)=10⁻⁷ m/s=100 nm/s. If the air is totally dry, i.e. the relative humidity 0%, the calculated 100 nm/s will be doubled.

Wind speed affects evaporation rate greatly, far utmost than temperature: e.g. if salt pool located at empty space with 10 m/s wind velocity, evaporation rate could soar up to 623 nm/s. Such a great benefit exists naturally, even needless of expensive wind turbine.

In winter season, direct evaporation by solar irradiation becomes slow, but indirect “escape” by strong wind scrapping effect can take domination. As the freezing point of the saturated salt water is −21.1° C., therefore the osmosis power generation system can be utilized almost year-round in all continents except the Arctic and Antarctic zones.

Even in extreme cold zone, maintaining a convenient schedule to break ice cover and clear ice on pool can also facilitate the “cold energy” utilization in the osmosis energy system. The accumulated ice can pile up nearby pool, and when temperature goes up above freezing point, melted ice will gradually return it to aquifer in a delayed long time that is determined by pool buffering volume.

Even during those days that the Great Nature cannot take away water timely by evaporation, the energy generation can still continue for a couple of days until too much water has osmosed into pool, so that concentration decreases too much then osmotic pressure plummets to half even down to as dilute as sea water. The gradual weakening course can be sensed easily if the bad weather goes on day by day, as concentration roughly reduces 10% per day, and will be cut half after 5 days if zero evaporation keeps on. Generally, when osmotic pressure is lower than a rated threshold, hydraulic motor will not rotate, unless there could be an intricate hydraulic circuit to stabilize pressure (just like a switching electric DC power supply suitable for wide voltage range from 90V to 240V). To cope with bad weather, tolerate it or try other heat source.

Another extreme situation is that: weather is good for quick evaporation, but the system is shut down for some reasons, such as maintenance or repair. In this case, water no longer osmosed into pool but the natural evaporation continues, so that salt crystallization will trend to deteriorate the flowability of working medium then will stall whole system after restart. To cope with shutdown, just cover the pool or use the opted cistern to store all solution of the pool during repair job for a couple of days.

If household energy consumption is intermittently low, the transient surplus energy can be sold for profit to local hydro grid during peak time, but just pause during off-peak time.

When the evaporation capacity of pool suits well the osmosis power generation, the output hydraulic pressure should be quite stable, even while the load is changing drastically under allowed range, the pressure fluctuation can be still just insignificant ripple wave, so as to supply AC electricity with stable voltage and constant frequency.

Salt impact on ecology can be easily avoid, provided pool liner is intact, so as to protect from leakage to adjacent soil, despite great bulk salt is dissolved.

Making & maintaining artificial saturated salt pool need massive backlog salt and water, and limit the osmosis energy capacity. However, there are some good places on the Earth where needless to worry about above demerit and the osmosis energy can become future energy star, such as those districts with high concentrated salt lake or abundant rock salt mineral resource.

The famous 605 km² Dead Sea fed by Jordan River is just a superior place to explore great osmosis energy, because it is a natural saturated salt sea, and with this excellent nature resource & subject inventions, scaling up to megawatts size will be economic & viable, as per the calculated power density 2.7 W/m², its theoretic power is about 1.6 GW at full time average, and if fully using such a huge power to energize RO desalination plants for potable water, the daily freshwater production capacity could be up to 20 times of the Dead Sea total evaporation: 20*3=60 million tons per day, then this world thirstiest district will be well quenched as well as the diminishing Dead Sea is replenished, and perhaps this great invention may bring perpetual peace to over there war-torn vast rim—the Middle East.

As to vast oceans, as long as one day the membrane technology is further developed, so as to enable it cheap enough, then seaside, especially estuaries where mouths of rivers join, will be good locations to massively harvest the inexhaustible osmosis energy in an economic way. The Great Nature always works hard to keep ocean salinity constant and river freshwater never dry.

### SUMMARY OF THE INVENTION

### The Integral Inter-Liquid Power Transmission Between Osmosis Circuit and Hydraulic Circuit

This innovative pressure retarded osmosis power system is consisted of large surface aqueous solution pool or equivalence, water source, osmosis membrane assembly, osmotic to hydraulic pressure transformer (also referred as pressure exchanger), hydraulic subsystem, electricity generator, electromagnetic valves and controller. There are also some auxiliaries, such as hydraulic hoses, pipes, filters, optional multi water source selector, sensors, etc.

The pool subsystem functions as indirect reverse osmosis by evaporation, mutual diffusion with the diluted solution, and the buffering benefit by smoothing energy output in days and nights.

To prevent pool from rain or snow or related flood dilution, a border of levee and transparent roof is necessary. Both the height of levee & depth of pool should be reasonably & economically determined. As to the height of roof, it is recommended of dog height or so, and its shade area should at least cover whole pool including surrounding levee.

For those very arid zones, the roof may be unnecessary, even in regular climate zones, also a rainproof cistern can substitute the roof. Local weather forecast service can be used to automatically transfer solution between the cistern and pool: if rains then retract else deploy. Hand operation of the said transfer job is another choice despite of little bit troublesome.

It is not enough to consider only savings on unnecessary costs relevant to roof posts & beams, for taking advantage of wind energy and facilitating vapor escape, also this low roof is needless of any wall and should deploy some chimneys with proper total updraft vent area.

According to experiment results on meteorological evaporation pans, black bottom of pool can greatly increase evaporation rate, and laying a black plastic liner is also a common practice in conditional solar evaporation salt ponds, therefore, the shallow pool in this system should be also well engineered with a black bottom liner. The other benefit is that it can simultaneously get rid of salt leakage to soil.

The additive cobalt blue dye is commonly used for quick evaporation, as it can help its hosted solution to absorb more solar energy, and can be considered with other factors case by case.

For those strong windy districts, and land area where is restrained, it may be a good idea to build a multi-story cubic rack to hold solution trays & connect together. Because wind energy is dominant, so every story may have same or almost same evaporation rate, thus small size land is multiplied by count of stories as the effective evaporation area, therefore capacity of osmotic energy will be increased by many times, or for same power output, this stacked pool will only occupy a fraction of normal area of a regular pool. For this case, some special configurations will apply on whole system.

The osmotic to hydraulic pressure transformer is a submersible unit that is soaked in aqueous solution pool. It comprises double osmosis compartments at both ends of 3-piston loaded shaft and inline oil compartment of hydraulic pump driven by the sliding shaft.

Because of its unique working ambiance or appearance, the osmotic-hydraulic pressure transformer is also rhetorically called “wet subsystem” or “wet unit” or “reciprocal syringe”. As its counterpart, the rest is called “dry subsystem” or “dry units”.

The wet unit can also be partially wet, as long as the embodiment of osmotic to hydraulic pressure transformer can “quarantine” the hydraulic partition from the osmotic partition, so as to be possible of only wetting the osmotic partition and leaving hydraulic partition dry.

Interfacing and Interacting with this wet subsystem, freshwater from water source should alternatingly osmose into both solution compartments, then the diluted solution is re-concentrated by quick diffusion after opening relevant valve, so that osmotic pressure can be effectively transmitted to the bidirectional inline hydraulic pump.

Water source is better from a drilled or dug well. River water is also good choice if project location is situated nearby a river, else, municipal tap water is the disadvantageous choice, because of not free, but the profit or benefit of energy generation may be canceled off a significant portion if local tap water is expensive.

There is no need for a pump to get water out of a pressureless water source, because osmotic pressure itself is power enough to suck it into solution side over a semi-permeable membrane, but starting the osmosis engine does need a priming job unless tap water.

For not clogging membrane, fine filters should be installed in line of water feed, so as to block 5+μm particles. As to the diffusion sections attached to the submersible unit, filters are optional, but better to deploy, because open pool may collect many dust.

Of the dry subsystem, hydraulic rectifier is analogous to the classical 4-diode bridge-style electronic rectifier, it comprises 4 hydraulic check valves, and the alternative pressurized oil current can be routed through different pair of check valves, depending on transient oil flow direction of the said pump, so as to ensure hydraulic loads can be always charged with same polarity of terminal pressure. As almost all hydraulic loads are driven not by AC—Alternative oil Current, but by DC—Direct oil Current, thus hydraulic rectification assembly is very important and luckily a check valve is usually cheap.

Analogous to electronic circuit: a capacitor with huge capacitance is always attached to rectifier for smoothing voltage, herein a hydraulic accumulator with large capacity is also needed for narrowing hydraulic pressure fluctuation.

Although unnecessary, it is still better to open the oil circuit to air after oil kinetics is exhausted by hydraulic loads, so as to dump to a sink tank with standard atmosphere pressure and satisfy many requirements: feedback of oil by automatic vacuum siphon, air bleeding, oil quality observation, oil changing and temperature sensing.

A hydraulic motor is used as hydraulic load, and a coupled electricity generator can be driven though some noise is inevitable. But in some special applications that only need mechanical power, hooking an electricity generator may be just optional, because many applications only or mainly need mechanic power, and the hydraulic motor itself is power enough to cope with large torque demand even without a geared transmission.

For both consuming by household or onsite regular appliances and selling surplus power to public hydro grid, a standard electricity generator can be hooked up to the hydraulic motor, so as to set correct frequency and voltage, unlike the PV system where an expensive DC-AC inverter has to be connected with panel cells.

Last but not least unit is the controller module. For intelligent control, it can embed a computer, though even a simple logic circuit board can work too for this not complex application. It secures the pistons of osmotic-hydraulic pressure transformer to work in endless reciprocal motion, so as to drive the power output hydraulic system by alternating pressurized oil current.

To determine when pistons ought to change stroking direction, a position sensor is needed. Based on the sensed data stream, the logic circuit or computer of the controller must send tiny switching energy in proper moments to different electromagnetic valves for turning on or off.

For starting & restarting & status remembrance, auxiliary rechargeable battery is necessary for the controller. When the osmosis engine is working, it is recommended to float-recharge the battery by the generator so as to keep it always full of charge.

As an extension of this invention, the so-called wet subsystem has not to be wet in all embodiments. In fact, it can also be dry, as long as each solution compartment is modified to host one drainage port and one recharge port, unlike the aforementioned wet type with only one diffusion port. But such configuration may suffer from higher cost, because quantity of valves must be doubled for drainage, and extra pair of pumps must be used for drawing solution, even one or two catchment pan(s) may need to be deployed underneath the solution compartments and routed to the pool, because current seal technologies face difficulty to cope with viscosity of regular solutions, hence minor solution leakage may be inevitable and is also allowed in a trade-off design despite of not beautiful. The control logics should be also perplexed to adapt the new configuration, so as to properly control the new added pumps and valves as well as timing arrangement.

The benefit of changing wet subsystem to dry is that the diluted exhaust solution can be drained far away from recharge pumping point, because pool is big enough, so as to instantly reset the concentration for next cycle of osmosis stroke to ideal state in the solution compartments, unlike the wet type needing some short preparation time for natural diffusion.

To instantiate subject invention, all afore-presented trial calculations are important reference source. Although the intermediate data and result data thereof are originated from the case study of 1000 kiwaho monthly energy consumption, the derived 1.4 kw power data is just simply based on the 24 hours full time run to use up the daily average quota 1000/30=33 kiwaho, however the 1.4 kw can only be regarded as the minimal power, never the max allowed power. In fact, the daily quota is determined by the pool size, and for the same afore-calculated pool size 520 m², even a random selected number 10 kw can be used as the rated power for determining osmosis engine all parameters, but it can use up the daily quota in just 3.3 hours if full loaded. The higher the power, the wider the potential scope of applications, because on the load side, any load does not have to exhaust all system power, even a system with 10 kw nameplate may temporarily just have a very light load, e.g. 100 watts. Scaleup of power is not complex, and its main requirement is to add more membranes area.

In conclusion, the Sun is the first energy source of entire system, though solar derivative wind energy is also involved, and transmitted by a series of intermediate energy conversion processes relevant to the novel interlink of osmosis solution circuit+hydraulic oil circuit+electric circuit, at last stage, fundamentally speaking, the osmosis power generator aka powerplant is indirectly powered by the very primary solar partial energy that was carried under the process of everlasting continuous evaporation.

### The Revolutionary Osmosis Battery for Energy Storage

The same system can also be embodied as osmosis battery with minor change, and I optimistically predict that this breakthrough revolutionary osmosis power storage system will economically replace the conventional PSH (Pumped Storage Hydroelectricity) system which station must rely on high elevated reservoir such as mountain top lake or deep excavated pit and average energy density is still so humble 1 kj/kg or 0.28 wh/kg for 100 meters water head, lower at least one order of magnitude behind the osmosis battery.

Once the subject invention is embodied as osmosis battery, there will be many stunning features and great advantages over conventional battery.

In essence, an osmosis battery is not the conventional electrochemical cell, but its first available power is mechanic power output by the hydraulic motor, and the derived power is the electricity after high efficient mechanic to electric energy conversion, therefore, this battery is more like a super wound spring of the old style clock.

The osmosis battery applications can be classified into two types: stationary and mobile.

A stationary battery can use 2 reservoirs with large volume, even as big as lakes, and onsite reverse osmosis equipment can recharge the battery in float mode by the usual solar and energy, also is possible to recharge by consuming cheap energy during the off-peak time of hydro grid. Even the battery's some key units can be reused for reverse osmosis, though dedicated units always better, such as the osmotic to hydraulic pressure transformer.

Because the surface energy density of PV panel is far great than solution pool 2.7 W/m², though PV is expensive, therefore the large surface pool for osmosis energy is just the “poor's Rolls-Royce” or desert choice with extreme fast evaporation, however if affordable for PV or with motivation of exploitation of cheap off-peak hydro, then using the system as an osmosis battery can render the pool unnecessary or redundant, alternatively, huge tanks or caverns could be the best choice because of its land saving and small footprint.

This type battery usually can be used for commercial large scale energy storage, it looms great potential to replace the low energy density yet economic PSH (Pumped Storage Hydroelectricity) system. It is also good choice for residential energy storage, so as to buffer the intermittent solar photovoltaic panels or wind system.

A mobile battery carries both water and solution tanks together for mobile use, and when the power is getting weak, usually head to a site with stationary osmosis battery, flush then refill all fresh liquid fuels—water and solution.

This type battery can be used to drive a vehicle, but its low energy density is embarrassing if comparing with the prevalent lithium ions battery, therefore osmosis battery is recommended to power inyard industrial tractors or forklifts or farm tractors, because the industry users or farmers can drive back in short distance for refueling, and they are affordable to use acreage size land for solar energy harvest, so as to recharge the exhaust solution by reverse osmosis and maintain a big stationary osmosis battery. Onboard biomass stove heating solution is optional.

Tractors prefer to be heavy just in need of traction, and that is why some tractors hang heavy wheel weights nearby rims on axle, even inner tubes are filled with calcium chloride liquid as ballast. Luckily, this invention can provide very heavy osmosis battery, up to tons on demand, so that any ballast is no longer necessary.

Anyway, the performance needs data to render, at first, do the analogy study in domain of electronics, before starting osmosis battery analysis.

For an electrochemical battery, e.g. 1.5V dry cell, it is regarded as almost exhausted if voltage drops to 1.25V and as end of life if drops to 1.06V. What are behind these 3 voltage data? As the power equals the square of voltage then divided by load resistance, i.e. V²/R, thus, at 1.25V or 1.25/1.5=83%, the remaining power=0.83²=70%; at 1.06V or 1.06/1.5=70.7%, the remaining power=0.707²=50%. In fact, not only the drycell, but also any one kind of other rechargeable batteries, such as lithium ion battery, lead acid battery, et cetera, all those follow the same percentage pattern.

Now for the osmosis battery, as the osmotic pressure is proportional to the concentration, thus the same percentage pattern should be applied for setting the allowable concentration range: 83% of saturated concentration as the threshold for the normal recharge action, so as to run at least 70% power; 71% as the critical point that the urgent action is to immediately do reverse osmosis and cut off loads, so as to run at least 50% power.

In previous some paragraph, the energy density on freshwater side is rendered as 15 wh/kg, but it is not on solution side, now given above percentage parameters, it is the good moment to figure out the storage energy density on solution side and on whole assembly.

Given 1.24 g/cm³ as the specific weight of the saturated salt solution, then 1 kg solution will occupy volume 806 ml, in order to dilute it 83%, the diluted volume should be 806/83%=971 ml, or water 971−806=165 ml must be poured in, or 165 grams water is needed. As per the afore-calculated energy density on water side 15 wh/kg under the assumption that the solution side supply is inexhaustible, thus after 165 grams water enters by osmosis, the output energy will be 0.165*15=2.475 wh 2.5 wh, therefore, the energy density on solution side is 2.5 wh/kg or 2.5/0.806=3.1 wh/L. In integral system measure, the corrected energy density is 2.5/(1+0.165)=2.15 wh/kg pr 2.5/0.971=2.57 wh/L.

Considering an osmosis battery will carry both water and solution together and use them like fuels, given the standard lowest allowable power=70% of the max state, then above-calculated data can further facilitate the calculation of optimal proportion between the 2 fuels water and solution after fresh refill: 165 ml vs 806 ml, or 1 vs 5 as volume ratio, or 1 vs 6 as weight ratio. If carry too much water, then the power at last moment will drop under the rated 70%, even too low to drive the terminal hydraulic motor; else if carry too less water, then the power output will be very stable, but soon later water tank may be empty.

If 50% power drop can be allowable, once again go through above calculation, then the new energy density on solution side is 3.7 wh/kg or 4.6 wh/L; on whole assembly: 2.78 wh/kg or 3.26 wh/L; on 2 fuels ratio of water to solution: 1 vs 2.4 as volume ratio or 1 vs 3 as weight ratio. The new results are based on the average value on water side: 15*(100%+50%)/2=11 wh/kg.

Above analyses are based on the allowable percentage of power drop just like a regular battery, but in fact even diluted to 83% of saturation, the salty solution is still 8.3 times stronger than seawater. The reason of only 70% power available is because that the osmosis resistance keeps constant, but if the resistance can be adjusted dynamically, then even the concentration is dropped to less than 50%, the power can still be stable as long as the resistance could drop accordingly, so that the potential energy density may increase 300% on the humble 2.57 wh/L.

Technically adjustment of osmosis resistance can be done by dynamically adding or removing the total area of membranes, e.g. if drop to 50% concentration, then increasement of 400% membranes area can keep power invariable, though osmotic pressure drops to 50%. But practically, such a smart realtime adjustment will complicate the osmosis battery engineering design, unless for stationary battery, thus it is a good practice to let an economic mobile osmosis battery mimick the simple conventional battery.

The role of a PSH station is as a load balancer and for energy storage to serve local distributed renewable power generators. However a PSH station is too picky to find a feasible place unless a rare special natural landscape could satisfy it, and that is why many countries fail to seek even one usable location to build a PSH station. In contrast, an osmosis energy storage station can be cheaply constructed anywhere.

Just do a rehearsal to estimate the profile data of a commercial large size osmosis battery. Assuming this battery is equivalent to the PSH of Canada Sir Adam Beck station: its water surface area is 300 hectare, waterhead 53 meters, power capacity is 174 Mw and energy capacity 1000 Mwh at minimal 2.5 meters of reservoir depth. As per afore-calculated data of membranes power density 2692 W/m², the total membranes area should be at least 174000000/2692=64636 m², and the total solution volume at least 1000*10⁶/4.6=217 million liters=217000 m³, total water volume=217000/2.4=90000 m³, the grand total volume=217000+90000=226000 m³=0.226 Mm³. Compared to the 3000000*2.5/1000000=7.5 Mm³ of the said PSH reservoir, this invention may save 1−0.226/7.5=97% volume. If using same area of land, then its pool depth is only 226000/(300*10000)=0.075 m=7.5 cm, and even without the reverse osmosis work while off-peak time, the solar evaporation 8220 m³ perday itself can still indirectly generate osmosis power: 300*10000*2.7=8100000 w=8.1 Mw at any time of 24 hours, as per the afore-calculated surface energy density 2.7 w/m². But this passive 8.1 Mw is just a fraction of the rated power 174 Mw with active reverse osmosis supported by off-peak power and all convergent feeding renewable energy, and the necessary rainproof top is expensive for so big surface, therefore, the 300 hectare land of PSH can be reduced to even zero, as long as a same volume deep cave is dug or a natural cavern is found. Compared with the low energy density 0.14 wh/L of above profiled example PSH station, there is a magnificent increase on this osmosis energy storage system, up to 4.6/0.14=33 times gain.

In fact, the afore-mentioned Dead Sea combined with the seawater source, does constitute the greatest nature osmosis battery in the world, if integrated with subject invention, and such a system is well being recharged anytime by natural solar evaporation without other source powered reverse osmosis.

As to the application in vehicles, the low energy density of osmosis may hinder application in long range shuttle vehicles, such as cars, but still favor in those heavy duty but short range shuttle utility vehicles, such as tractors, forklifts, excavators.

Take a trial calculation. For the most favorite yard work forklifts, the popular power is about 30 horse power, i.e. 23 kw, and usually, a conventional lead-acid battery powered forklift weighs about 5 tons. Because of the battery not heavy enough, the frame has to be built with very thick steel, even bound with extra heavy cast block as ballast.

Now think about a forklift with osmosis battery. A fresh refill better stores circa 25 kiwaho energy, as per the estimation 3.7 wh/kg based on allowable 71% concentration drop, the dead weight at least 25000/3.7=6755 kg, the according volume 6.7 m³ acceptable, and it can work for 1.1 hours for the same power. The minimal area of membranes is 23000/2692=8.5 m², the volume and weight of membranes cartridges seem too small to count about. More amazingly, the pristine powerful hydraulic motor of osmosis battery can directly drive the forklift booming mechanism as well as the its wheels, thus the new forklift can be made lightly and cheaply with thin frame & without ballast, in turn, transporting an unloaded forklift becomes easy.

If 50% concentration drop is allowed, the energy density can further increase, so that the dead weight can significantly decrease, however the power will decrease too, unless special stabilization technology is applied.

Too heavy for cars? Yes, but at least no problem to replace the conventional lead-acid batteries. As the osmosis battery outputs mechanic work first, thus no longer need an electric motor plus thick copper cable to start a car. For headlights and dashboard fancy electric gadgets, it is probably capable enough to couple a 300 watts DC generator to the battery's hydraulic motor.

A regular lead battery is always suffering from slow internal discharge, thus if shelf time over 1 month, it may fail to start a car if not recharge before reuse, because of significant accumulated internal discharge. Luckily, for an osmosis battery, even shelf time over 20 years, it may still be full capacity, as long as its valves have been fully closed before long time storage.

Starting a car normally needs to turn key 3 seconds, and regular starter motor about 1 kw, thus 3 kj or less than 1 wh energy is OK per start event. Because of zero internal discharge, it can be acceptable and economic to only reserve 20 times starting capacity or 60 wh energy inside the osmosis battery, thus its dead weight is estimated about: 60/2.78=22 kg, and it is on par with a regular lead acid battery. While a car is running, its engine can do RO to recharge the osmosis battery, so as to compensate the starting loss. The global huge market of car lead acid batteries is really a big environment concern, because of the harmful lead and acid pollution.

One day in future, provided supply stations of saturated solution and water are densely distributed along highways and streets, even the osmosis engine powered cars are possible to run anywhere without too heavy liquid loads because of easy accessible refueling, and such a marvelous situation can greatly reduce the dependence on fossil fuels, because refuel stations can primarily utilize solar energy to conduct RO operation, especially those stations beside highways with lots of lands for PV or natural evaporation.

Even an osmosis powered ship can be built, and it is especially good for the Dead Sea navigation.

### The Method to Change a Desert Unto Oasis by Massively Seawater Intake

According to the recognized theory, deserts are caused by too big evaporation and small precipitation, though I have extra theory: the anomaly skyward high energy density from the hot core of Earth may dominate its evolution. The average skyward energy density of subterrane is about 0.087 w/m², however all deserts are much greater than the average, and the earth mantle underneath may be reasonably thinner.

The evaporation rate on deserts is usually 3 times of the regular inhabitable zones, and the osmosis power system can favorably take such a great advantage for same multiplication on energy density.

As per subject inventions, huge osmosis energy can be extracted during osmosis water transfer process of the less concentrated liquid diffusing into high concentrated liquid via semi-permeable membranes. Provided the elevation of a desert is less than 5000 meters, then drawing seawater into a saturated salt lake will theoretically not consume extra energy.

Luckily many deserts on the world are mediocre elevation, that means: considering the offset of credit to debit, seawater transportation into the desert not only looks like free, but also can generate huge power for desert communities, and more amazingly the desert will gradually become oasis after long time application, because large amount of evaporation will increase the local precipitation significantly, so as to compact the drift sand then ready for vegetation.

Large area simple solar evaporation shallow pools are needed for massively drying seawater into saturated salt solution, plus one large manmade salt lake should be planned ahead and prepared, so as to store the quality solution, as well as another proportionally smaller lake should be dug beside the salt lake, so as to serve as the reservoir of the incoming seawater.

Supposedly the max power should be proportional to the sum of surface area of the saturated salt lake and the saturating evaporation pools, thus their area should be as large as possible until capped by project budget. The expectation of power density is 2*2.7=5.4 w/m² above.

Some pools can be reserved for sea salt production, so as to secure more income sources.

If there is abundant salt resource in the desert, then seawater intake could generate power at the first day, though the power is not satisfactory because of small amount of mixing seawater with inventory salt. Anyway the power will gradually increase with the ongoing seawater intake.

The salt inventory is not mandatory, even zero is acceptable, because after about half month, the first batch of saturated salt solution in shallow pools will be ready for drainage to the salt lake, and the quality solution inventory will be gradually accumulated day by day with quick evaporation. As long as the accumulation reach a decent amount, the osmosis pair of seawater and saturated salt solution can begin to generate power.

More favorably, the evaporation pools do not have to be covered by a transparent roof, because the desert climate almost never rains. This feature will greatly save project cost!

Although pumping from sea to desert consumes energy, however the osmosis energy harvest can easily offset the pump expenditure. Not only energy production, but also the sea salt product can make a decent profit.

The size of the 2 manmade lakes and all evaporation pools can be gradually enlarged in future operation of the powerplant, so as to expand the system capacity with a sustainable pace, and the energy demand for later incremental extension project should be self-sufficient.

With the newborn of a desert community, drinkable water is the basic and vast demanding requisite, thus, the freshwater production line should be built onsite. A RO parasitic factory is the favorite choice, and the PRO generated energy can partially consumed by the RO process. The RO rejected seawater renders higher concentration than regular seawater, and can be dumped into the saturating evaporation pools, or the sea salt production pools.

The distance between desert and sea affects the difficulty scale of pipeline project. The more mountains in-between, the more relay pump stations there will be. For long distant seawater transportation, the whole pipeline is usually not sealed because of midway pumps insertion and localized open reservoirs, but for short distance, full seal is possible.

For ideal sealed pipeline, the pump does not have to work constantly after initial start, because the osmosis process can suck automatically, and the reduced PRO pressure=osmotic pressure between saturated solution and seawater (bar)−elevation (meter)/10.

Some locations may not have quicksand but rocks, it still can be regarded as desert as long as climate arid enough. Even a river may pass through an arid district, such as the Paradox Basin in the USA, and usually there is inexhaustible salt deposit therein, thus the salt in situ and the river water can be utilized independently or combinedly with seawater intake.

### DETAIL DESCRIPTION ON ALL DRAWINGS, POSSIBLE EMBODIMENTS & RELEVANT ANALYSIS

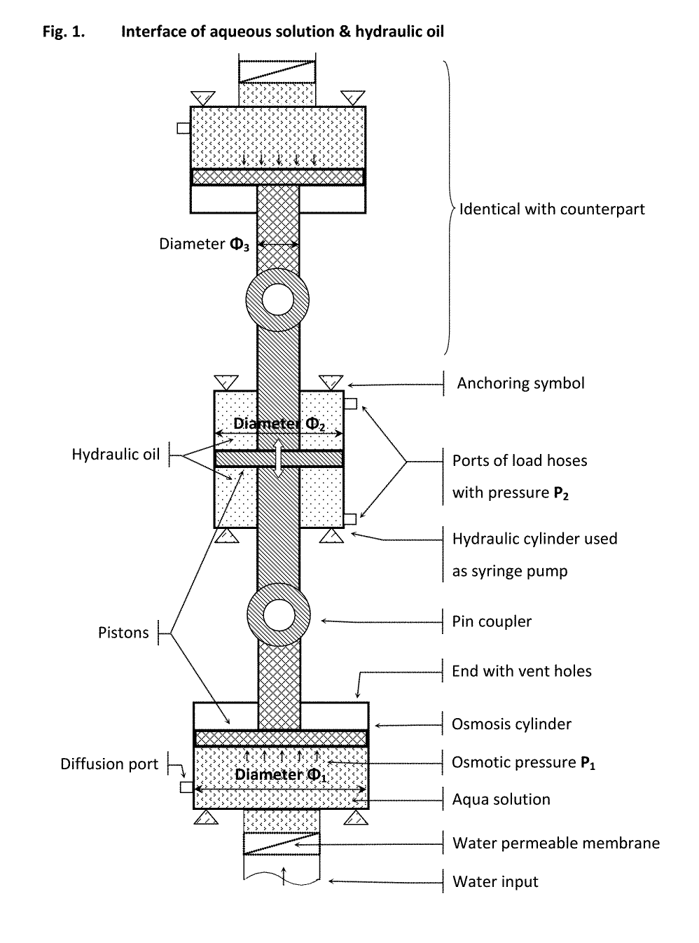

### Description on FIG. 1

FIG. 1 shows the closeup view of interface between aqueous solution and hydraulic oil.

It is purposed to only emphasize on the mutual isolation between hydraulic oil and osmosis solution, not restrict how to realize isolation or how far between their holding compartments.

As to embodiment forms, there are many possible, this figure just illustrates one form.

In this figure, the semi-permeable membrane is drawn in a doted-Z shape; aqueous solution and oil are both drawn in wavy area, and respectively indicated by callout labels; anchoring points are drawn in shaded triangle symbol; all unmentioned elements are marked by callout labels, and some important elements will be described in more detail hereafter if necessary.

Although the hydraulic cylinder & osmosis cylinder are drawn as different components & coupled by pins, however it may be only good for DlYers but manufacturers may prefer to fabricate them as a whole unit for massive production.

The piston diameter of osmosis cylinder is marked as Φ₁, hydraulic piston as Φ₂, shaft diameter as Φ₃, and the osmotic pressure is P₁, oil pressure P₂. There is equation for above 5 parameters:

P₁*πΦ₁²/4=P₂*π(Φ₂²−Φ₃²)/4 or P₂=P₁*Φ₁²/(Φ₂²−Φ₃²)

Obviously if Φ₁>Φ₂ then oil pressure will be greater than osmotic pressure, vice versa, that is why sometimes it is also named as pressure transformer. Therefore it is possible to pre-design working states for solution & oil sides to enable both run in respective isolated space with best performance without the bothersome blend of water and oil.

For example, if the saturated salt solution is used, then the osmotic pressure is commensurate with the rated pressure for commercial hydraulic products, hence Φ₁≈(Φ₂²−Φ₃²)^{0.5} is usually OK, but if seawater is used, then Φ₁≈4.5(Φ₂²−Φ₃²))^{0.5} shall be the correct quantity correlation of the piston's diameters, so as to still enjoy popular hydraulic parts.

During the process of freshwater osmosis through the membrane, the pushed oil side will send powerful oil current to the connected hydraulic hose, so as to do work in loads; meanwhile, oil in the opposite side of hydraulic piston will appear vacuum state, so as to suck inward the return oil from loads exhaust port or oil tank with air breather.

Despite that minor leakage may occur around rim of osmosis piston because of not ideal viscosity of solution & potential corrosion, anyway, it is still tolerable and worthy even periodic change of some cheap parts may be inevitable, just based on good expectation of its efficient conversion from osmotic power to hydraulic power.

More similar embodiments are presented in next two figures.

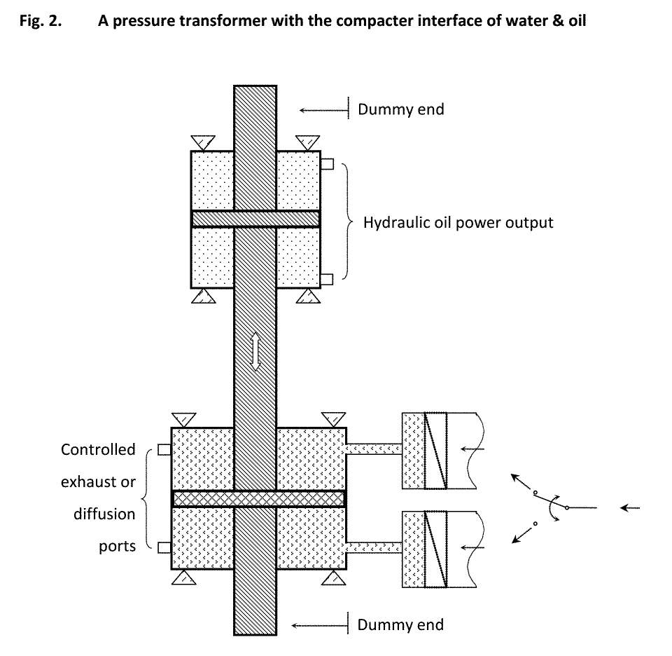

### Description on FIG. 2

FIG. 2 shows another variety of the pressure transformer with the compactor interface of water & hydraulic oil.

There is a dummy end in either oil cylinder or water cylinder, so as to render same pressure in bilateral compartments separated by the piston. The max protrudeable length of dummy ends should be at least the same length of respective cylinder, so as not to expose the shaft hole while the end is fully retracted inwards.

More materials for the shaft and sealant parts plus more machining jobs are needed for such an embodiment, but it is still worthwhile in many occasions.

Although given a name “dummy ends”, it is still the user's free choice to assign those ends for whatever purpose, such as to actuate a position switch, to drive some auxiliaries, etc.

This embodiment can allow partial wet application.

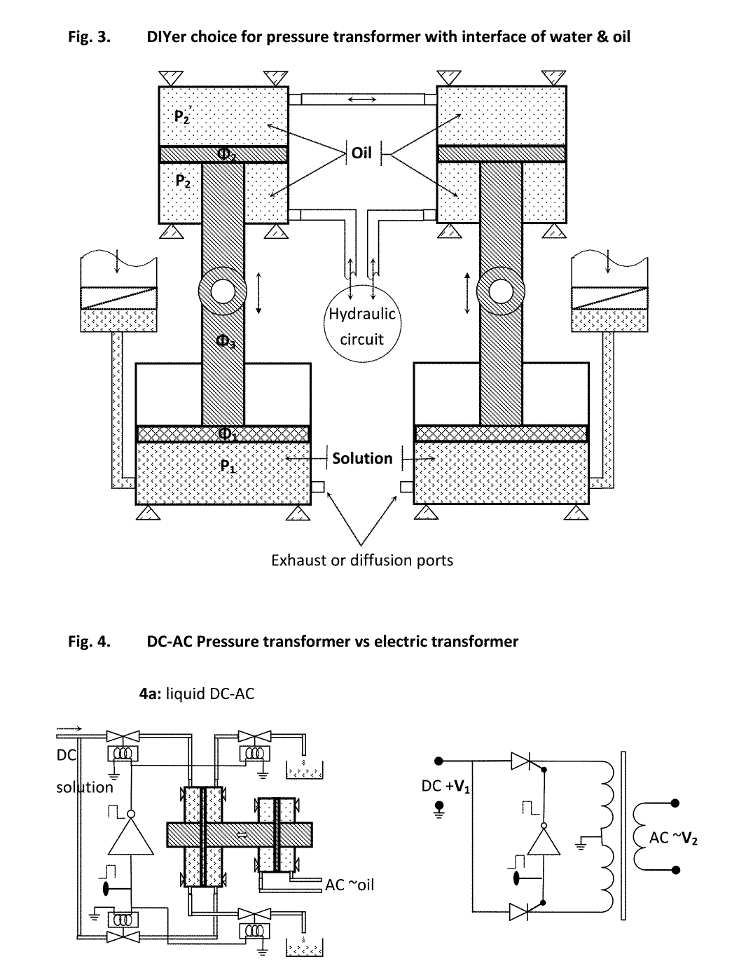

### Description on FIG. 3

FIG. 3 shows a DIY choice to build a pressure transformer with interface of aqueous solution and hydraulic oil, by using market most abundant regular hydraulic cylinders. In contrast with previous embodiment, it uses 4 cylinders in total, one more than previous.

With the marked all parameters, the shaft will go downwards, now this force equation is true:

P₁*πΦ₁²/4=P₂*π(Φ₂²−Φ₃²)/4

or the hydraulic oil pressure for output:

P₂=P₁*Φ₁²/(Φ₂²−Φ₃²)

The solution cylinders can only be pressurized unilaterally, thus just unplug the upside holes, and hose the downside holes to the mutual-switching membranes modules.

Although it is not recommended by all manufacturers to use commercial available hydraulic cylinders with aqueous solution, anyway, the subject inventions encourage this trade-off choice, because hydraulic cylinders are usually not expensive, and other hydraulic products are not supposed so, thus even periodic replacement of those “rebel cylinders” is easy and affordable.

The hydraulic oil cylinders render different pressures across 2 sides of pistons, because of different liquid contact area, however this differential does not affect hydraulic power output.

The 2 rod-less compartments of the 2 cylinders are connected together, and prefilled enough hydraulic oil, so as to make sure: if one piston touching the bottom end, then the other piston will touch the top end. Obviously the oil in these 2 compartments is seclusive, isolated with the oil that is in the opposite compartments and directly output hydraulic power.

This embodiment can also allow partial wet application, i.e. only the osmotic partition submersible, and the hydraulic partition can stay dry.

Until hereby, 3 different forms with same function are rendered, though not all possible forms are exhaustively enumerated, as others may be too complex, such as this undrawn form: 2 parallel gear bars aka racks meshed with a central idle gear or pinion, and every rack is used as reciprocal shaft with its rest section connected to a piston of osmosis cylinder.

### Description on FIG. 4

FIG. 4 shows the equivalence between a liquid DC-AC plus pressure transformer and an electric DC-AC plus voltage transformer. It contains only 2 sub-figures for contrast.

Sub-figure 4a is the fluidic version with embedded PRO. While the solution osmotic pressure is retarded in one compartment, by the hydraulic load in the transformer “secondary coil”, the pressure in opposite solution compartment will be “grounded” to atmosphere and gently squeezed out. Because retardation & squeeze events occur in 2 places, thus one tandem of 2 electromagnetic valves is needed to turn on simultaneously. When alternating to another half cycle, another tandem of 2 valves is supposed to turn on and previous tandem turns off. Once whole cycle is done, next cycle continues, so as to output ongoing AC hydraulic oil power.

For drawing convenience, there are 2 tanks in this sub-figure, however only one tank exists. In analogy, the tank is equivalent to the grounding concept in electric domain.

Sub-figure 4b is the equivalent electric version. The conventional voltage transformer comprises the primary 2 coils and secondary coil as output. In primary aka input side of the transformer, there is a simple half-wave DC-AC convertor. The input is DC voltage, it is alternatingly sent to one of 2 coils wired in serial, by the 2 thyristors, and the joint point of the 2 coils is grounded as zero volt reference.

Both versions need switching signal to trigger valves or thyristors in proper timing logics, and this is usually executed by a logic control module. A computer could be used for this purpose.

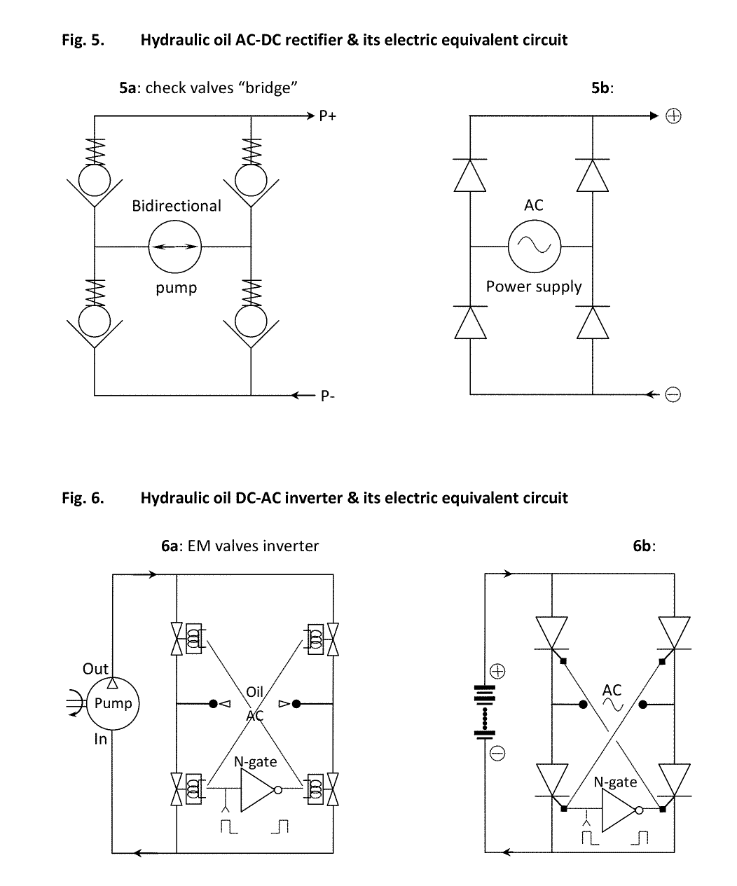

### Description on FIG. 5

FIG. 5 shows a hydraulic rectifier and its electric equivalent circuit. It contains only 2 sub-figures.

Of which, the sub-figure 5a illustrates a bridge-style hydraulic rectifier that simply comprises 4 hydraulic check valves. The pressurized oil always flows out of the marked port P+, and returns to the port P− without exception, but anyway, the marked bidirectional hydraulic pump can infuse oil in any random direction while the pressure polarity of output hydraulic current can still keep invariant.

In a sense, it is just like as a high fidelity translation of the classical electronic bridge-style rectifier consisted of 4 diodes, and the sub-figure Sb just shows its circuit that can also be seen in all relevant basic textbooks.

As long as people can understand the simple electronic version rectifier, inspired by analogy, they can automatically understand how the mechanic version rectifier works.

Some electronic factories encapsulate 4 properly wired diodes into a compact single rectifier component; therefore, the same trend will prevail soon to fabricate the whole piece fluidic rectifier with 4 embedded check valves, if its applications become popular.

### Description on FIG. 6

FIG. 6 shows a DC to AC inverter for hydraulic oil and its electric equivalent circuit. It contains only 2 sub-figures.

The pressurized oil current cannot change or alternate its flow direction at high frequency like its electronic counterpart AC current, because of inertia and “oil hammer” effect, that is why all market available hydraulic pumps are the type of DC.

Yet in subject inventions, a slowly alternating oil current hydraulic pump is a must-have in order to reciprocally drive the reverse osmosis process in the similar or same unit that is used for forward osmosis retarded power generation.

The sub-figure 6a shows a method to convert a normal DC hydraulic pump into a general oil AC power supply, just similar to a DC-AC electricity power inverter.

There are 4 electromagnetic hydraulic valves in this hydraulic DC-AC inverter. They teamwork in 2 pairs, and each 2 valves in diagonal positions must form a pair that is synchronously controlled. When one pair is turned on, the other pair will be turned off, so as to generate the alternating oil current. The NOT-gate component can properly drive the 2 pairs of valves.

The sub-figure 6b is just the equivalent circuit, but in electron current version. Instead of electromagnetic valves, there are 4 thyristors that harmonically work together to complete the DC-AC conversion. The NOT-gate component can properly drive the similarly paired thyristors.

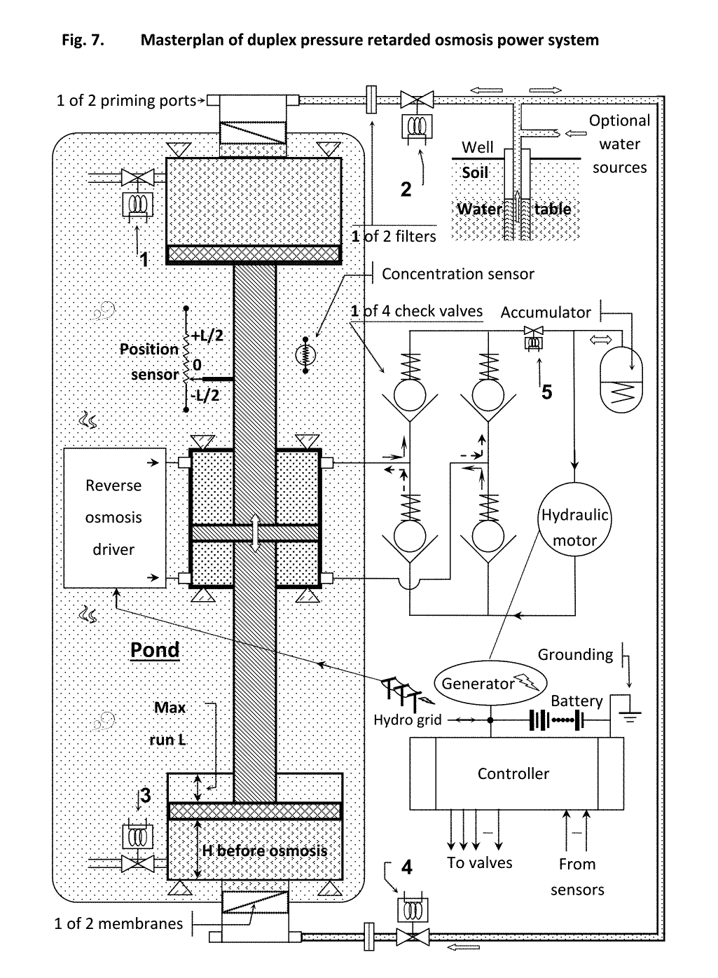

### Description on FIG. 7

FIG. 7 illustrates the masterplan of duplex pressure retarded osmosis power system.

In this figure, there are mainly 3 subsystems: pool or pond subsystem, wet subsystem and dry subsystem. The left side large shaded rectangular area with 4 round corners is the pool (sometimes may referred as panel or pond) subsystem; all components inside the pool constitute the wet subsystem; all the remainings constitute the dry subsystem.

The pool and wet subsystems are well detailed in previous paragraphs, further, another visible feature is still worthy to mention: unlike in the first figure, herein no pins to couple the solution-side shaft and oil-side shaft, the single shaft is common for all pistons and inserted into all liquid compartments, obviously not a DIY version, but a whole unit that is the preferred choice of those interested manufacturers.

Of course, though undrawn, the DlYers or contractors can still use 2 solution cylinders and 1 oil cylinder, then pin together to build the wet unit with equivalent function.

If the osmotic to hydraulic pressure transformer employs the embodiment drawn in the FIG. 2 or FIG. 3, then the wet unit can be partial wet, and its hydraulic partition can be dry, so as to extend its life expectation.

The dry subsystem can be further divided to 3 functional modules: hydraulic power generation, electric module of timing+sensing+valves controlling, and the freshwater plumbing circuit.

The hydraulic power generation module comprises a rectification assembly for alternating oil current, a hydraulic accumulator, a hydraulic motor and an electricity generator. High strength hydraulic hoses must be used anywhere inside this module to connect different parts: 4 check valves, motor, accumulator, and may include hydraulic tank if opted. Two pieces of hydraulic hoses bridge the wet subsystem and this module together.

The electric module comprises a logic controlling circuit, rechargeable auxiliary battery, and cables for sensor data acquisition and valves (and pump in some variant settings) governance.

The low pressure plumbing module provides freshwater for the high concentrated solution to suck through the semi-permeable membranes in osmosis rationale. In principle, osmotic pressure is just negative chemical potentiality, thus the underground water will be exerted negative pressure, and that is why needless of a pump for lifting to the osmotic-hydraulic pressure transformer soaked in the inground pool.

Although freshwater is the best choice in the plumbing module, however it is never a hard requirement, even brackish water or seawater is allowed, as long as the pooled solution is far concentrated than the plumbing side.

For example, in the Israel, both regular seawater & quasi saturated salt water are accessible: the former in the nearby Mediterranean Sea, the latter in the nearby Dead Sea, but freshwater is very precious, therefore, an alternative system still works even the plumbing module is hooked to the Mediterranean Sea, as well as the Dead Sea is used as the perfect saturated solution reservoir, because the salinity differentia in such a system is still great enough!

There are 2 solution compartments for osmosis in the wet subsystem, and they are working in alternating mode, thus the plumbing module must split the main conduit of water source into 2 branches, so as to feed the separative compartments. A drilled well and aquifer are drawn about the left top corner of this figure, and the plumbing module should also be switchable to other water sources, e.g. tap water supplied by local municipality, or river water if permitted.

Although the system can be shutdown if weather not favorable, anyway, as an option, a reverse osmosis scheme is drawn in a functional box so as to use the hydro grid power during the off-peak time in advantage of cheap rate. Its details will be briefed in next figure. The relevant valve 5 should turn off, if reverse osmosis is in action.

The concentration meter in the pool is mainly conserved for the RO subsystem, so as to judge whether the solution is too dilute because of too bad weather, such as foggy days or too cold.

In equivalence, even a simple lever sensor for realtime measuring pool depth can be used as concentration meter. As the osmosis concerned concentration is in unit of molarity, i.e. moles per liter, and the pool area is constant, thus the volume is in linear relation with level or depth reading, in turn, the concentration is proportional to the depth.

As long as the initial level is marked as the height or depth coordinate h₀ which corresponding concentration is the saturated value C₀, then there is a math function for the concentration at any level C(h)=C₀*h₀/h, here h>h₀, otherwise, salt grains will precipitate.

The cylinder volume and dimension can be determined mainly by the required reciprocal period, power rating, allowable safe rod velocity. The guidance of design favors in small size with performance as first consideration.

All electromagnetic valves and electric switches are controlled by the electric module that functions as the system brain and may be implemented with a computer. As to the wiring, the afore-described FIG. 4 does illustrate the control circuit. In fact, it is the first stage of whole system, and just a DC to AC inverter with different isolated liquids, plus a pressure transformer.

Overview on this masterplan figure, wonder may rise: now that the pristine osmotic pressure is DC, the hydraulic motor is DC, why must this invention complexly sandwich an AC in-between to form DC-AC-DC chain?

The reason: because human lives in a limited time and space, despite of limitless infinite cosmos, but all DC procedures tend to exhaust the time and space in only one direction, e.g. if drive a piston by DC force forever, then infinite one dimension space will be needed, thus DC is not sustainable, unless cycling DC into AC. As to the DC motor, DC is just the input, and its shaft rotation is the final AC output.

Although it could be tried only to use the simplest one DC fluid circuit, e.g. a huge size solution container with one hose to osmosis membrane high pressure side and another hose to DC solution high pressure motor, however it is neither feasible nor economic because the huge solution container must endure pressure as high as 500+ times atmosphere, and also be subject to erosion, and such an expensive container is never acceptable. Nevertheless, if a regular hydraulic motor is not using the prescribed oil, but the erosive solution, then the frequent change of expensive motors will cost a fortune!

Therefore, the multiple times DC-AC change link is the best trade-off choice, as it enables the high pressure compartments as small as possible, as well as decent performance.

It is very important to emphasize that this masterplan can also stands for an osmosis battery system as long as simply replacing the pool with either a stationary or mobile tank, and it is unnecessary to redraw a reduplicate figure that would be almost same but with a new label.

In conclusion, most genius inventive points are manifested by this figure of masterplan: i. transmitting osmotic pressure to hydraulic oil pressure; ii. creating alternating oil current that carries energy in a similar way like an electric AC power supply; iii. converting oil AC into oil DC by a fluidic rectifier that simply comprises four cheap check valves; iv. smoothing the oil DC output by accumulator like an electrolytic capacitor; v. driving a hydraulic motor by the oil DC; vi. driving an electricity generator by the hydraulic motor.

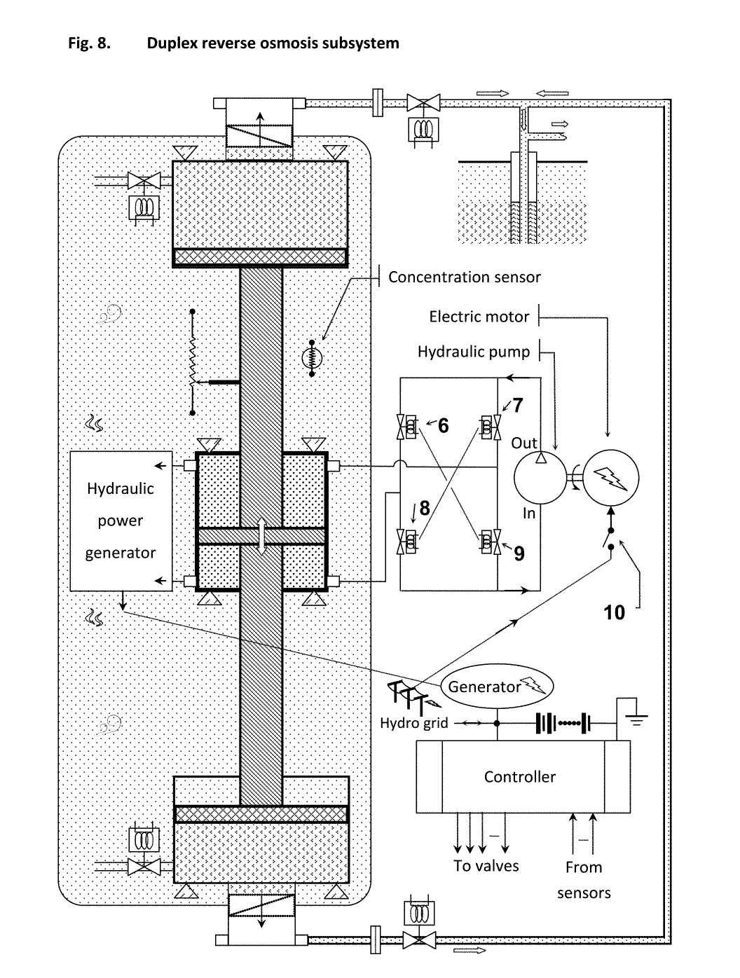

### Description on FIG. 8

FIG. 8 shows the duplex reverse osmosis subsystem.

This figure is just drawn by modification on previous masterplan figure, and most graphic elements are not changed, except abstraction of hydraulic power generation by a functional box, as well as emphasis on reverse osmosis key parts.

For concise, all reduplicate labels are removed, even though, it is still easy to identify any untagged component by familiarization with all previous rich-tagged figures.

The upmost important drawing elements are those parts relevant to the reverse osmosis subsystem: the 4 electromagnetic valves for hydraulic DC-AC oil current inverter, the regular hydraulic pump, the electric motor, and the logic control hosted by the controller for the hydraulic inverter plus the peripheral valves of solution compartments.

It is acceptable to use same “wet unit” for the reverse osmosis, and better to have another pair of hydraulic ports for driving reverse osmosis, though it is also possible to share one pair of hydraulic ports for both PRO & RO, as long as a pair of 3-way fittings are there for split.

The hydro grid power is used to run the electric motor that in turn drives the hydraulic pump. As a profitable choice, it is better to do reverse osmosis during off-peak time with cheap rate, if bad weather lasting too long time.

If wet unit is shared, as membrane is same, in order to get same RO flow rate, the net pressure after deduction of osmotic pressure should be the same with PRO, therefore the hydraulic pressure should equal twice of osmotic pressure, but such a double may exceed the rated pressure of a regular hydraulic pump.

To avoid above dilemma, it is better to not share, but to use an independent similar wet unit, so as to install the dedicated low resistance RO membranes for high flow rate & fast operation. To match this new wet unit with hydraulic pump, its geometry should be recalculated from equation: P₂*(Φ₂²−Φ₃²)=P₁*Φ₁², where P₁ is the sum of osmotic pressure plus RO net pressure, P₂ pressure for common hydraulic components, the rest 3 diameter parameters just the same definition like the PRO wet unit.

If using another wet unit for RO, the controller should be reprogrammed to support it for properly controlling all new set of relevant valves, and the plumbing subsystem must also be adjusted for dispose of RO output freshwater. Of course, the generated freshwater is drinkable, thus it is unnecessary to dump all into well or top soil.

The RO subsystem is optional, so if hydro grid is unavailable or no special discount for off-peak price, just only invest for the PRO system, and use it when good weather & abide if bad weather.

There should be an algorithm to govern the switching between PRO & RO, especially if they share the wet unit, and it will be briefed in later figure.

### Description on FIG. 9

FIG. 9 shows the timing of valves, assuming the power output is constant. It contains only 3 sub-figures.

The wet unit or so-called reciprocal syringe is supposed to work at accurate pace for converting osmosis power to hydraulic power.

The sub-figure 9a shows the dynamic position of the wet unit's common shaft with time elapse within a full period, and the “position=0” means the center position while both compartments hold same volume of solution. The “L” denotes the max run length of the shaft between the coordinate valve −L/2 and +L/2.

Sub-figure 9b shows the status change of the valve #1 and #4: OFF during the first half cycle and ON in the next half cycle.

Sub-figure 9c shows the status change of the valve #2 and #3: ON during the first half cycle and OFF in the next half cycle.

The valve of position is reported to the controller by the position sensor, and the controller decides when to turn on or off any relevant individual valve.

In fact, if the power output is not constant, or loads are changing, every single period may display different position-time curve, and valve states corresponds synchronously.

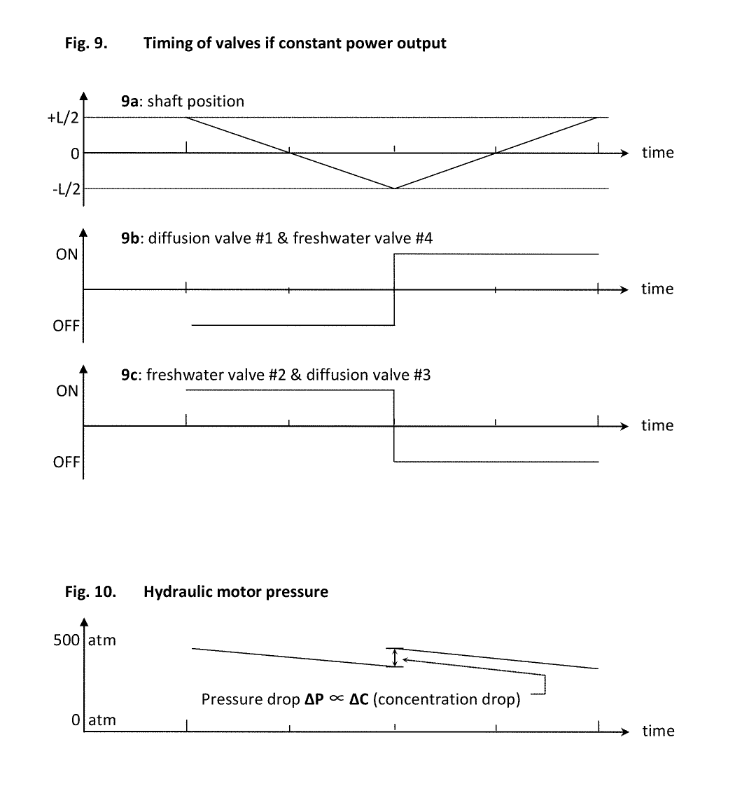

### Description on FIG. 10

FIG. 10 shows the pressure curve charged on the hydraulic motor.

When the hydraulic motor is working hard to output energy onto loads, the oil pressure inside hoses will change, though the associated hydraulic accumulator can smooth the pressure. The pressure curve looks like sawtooth, and minor pressure oscillation usually does not affect the operational stability.

In the analogous electronic version, the unregulated immediate output of AC-DC rectifier also shows similar ripple waves on the paralleled capacitor, though a modern switching DC power supply can output very stable voltage with smart feedback-regulated circuit.

The tooth height reflects the pressure drop ΔP, and generally speaking, it is proportional to the loads duty & concentration drop ΔC during the osmosis progression in a solution compartment.

The ΔC is roughly determined by the (L/H)*C, where L is the max stroke length of the shaft, H the height before a fresh charged solution starts osmosis, and C the original concentration.

Usually, the ΔC/C or L/H in a good design is less than 10%, so as for basic stable pressure output. The smaller the ΔC/C, the higher the stability & robustness, but too small will see high frequent reciprocal shaft motion that may quicken the wearing and even deteriorate system performance because of fluidic inertia & switch delay of valves; otherwise, too big will see an unstable and weak output, and it is also not necessary because the soaked wet unit can conveniently discharge the diluted solution & recharge high concentration solution by quick diffusion with a little overhead energy consumption on those electromagnetic valves.

With assistance of the shaft position sensor, it is possible to adjust the L & H parameters in a reasonable range, so as to match the pool size, weather condition, and loads capacity.

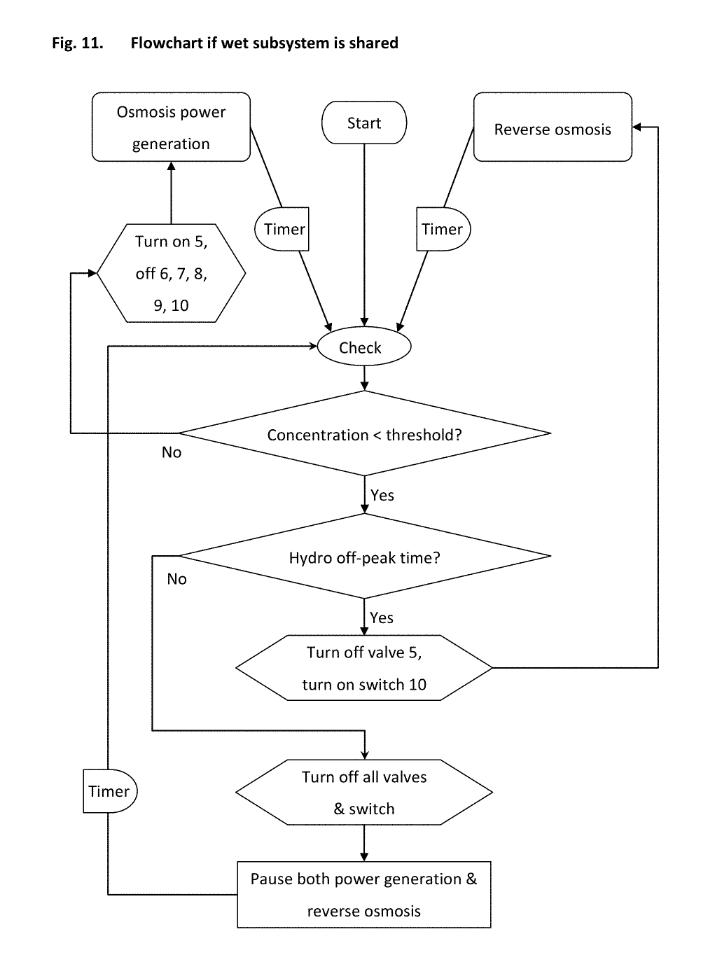

### Description on FIG. 11

FIG. 11 shows the program flowchart of PRO and RO switching algorithm.

It reflects following algorithm:

If the concentration meter reports “NORMAL” condition, then let “business as usual”, i.e. continue osmosis power generation, else alarm a warning of “TOO LOW”, and if now is the off-peak time of hydro grid, then after turn off the valve 5 and turn on the switch 10, start the reverse osmosis job, else turn off all valves & switches, thenafter, pause both power generation & reverse osmosis, and simply recheck whether the weather getting better or wait until off-time becomes ready. Such a loop of processes will go on and on.

More valves and switches must be properly reset as the preparation job for restart of PRO power generation: turn on the valve 5, turn off the valves 6, 7, 8, 9, and the switch 10 also needs to be turned off, so as to stop the electric motor.

To optimize controller performance, it is a good practice to set 3 timers for state check, the first timer is for the osmosis power generation, the second for the reverse osmosis, the last for the pause-then-wait.

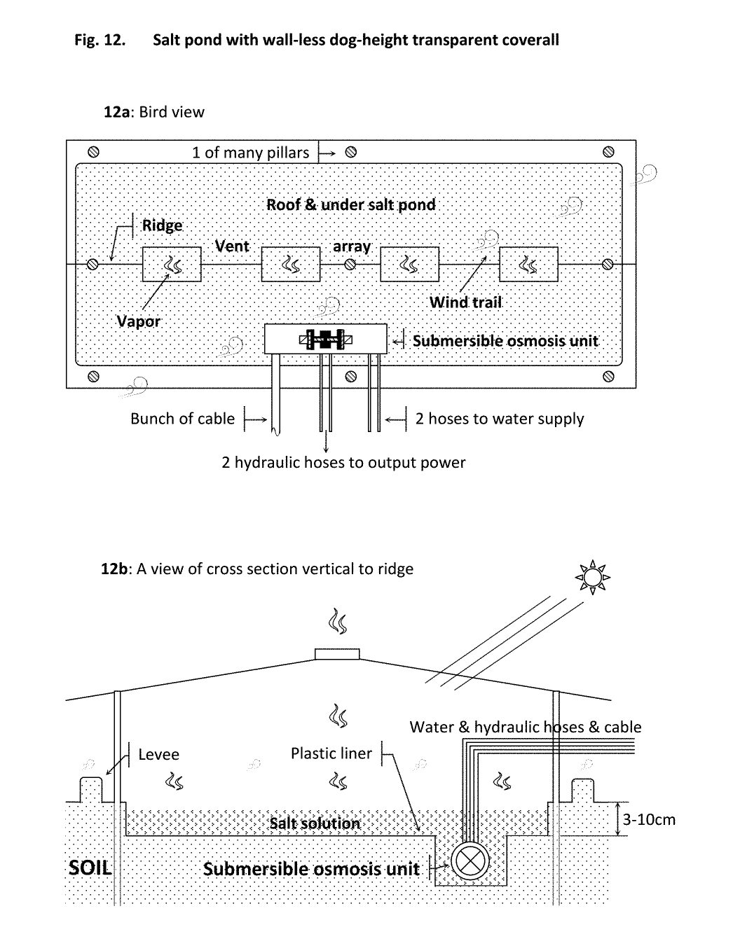

### Description on FIG. 12

FIG. 12 shows the salt solution pool or pond with wall-less dog-height transparent coverall roof. It contains only 2 sub-figures.

Although full open air is good for evaporation, perhaps a spell of rain may undo many days effort of evaporation. A roof can fix the worry, however it must be transparent, so as not to shield the important sunshine; and walls can block winds or vapor flow, so do not enclose the roof with walls, so as to let winds assist evaporation and blow away vapor.

To minimize this structure, just let the height as low as reasonable, even the height can just let dogs walk under the roof. Even truss-less roof could be acceptable, because of its light duty.

The sub-figure 12a is a bird view of sample pool settings. It shows the roof, pillars, an array of vent ports, the under salt solution pool, and the submersible osmosis unit plus the peripheral hoses & cables that leads to the undrawn dry units.

In usual, polycarbonate is recommended for roof material, because of its high transparency as well as the great mechanic strength.

Sub-figure 12b is the view of cross section vertical to the ridge. It shows the levee, the black plastic liner, the soil, the submersible osmosis unit, hoses, cables, and how shallow the roof and solution depth.

The recommended depth is about 3 to 10 centimeters, but not limited to if users prefer deeper. As the average economic depth may not be enough to soak entire wet unit, thus a localized pit within the pool should be dug, so as to provide the wet unit with accommodation.

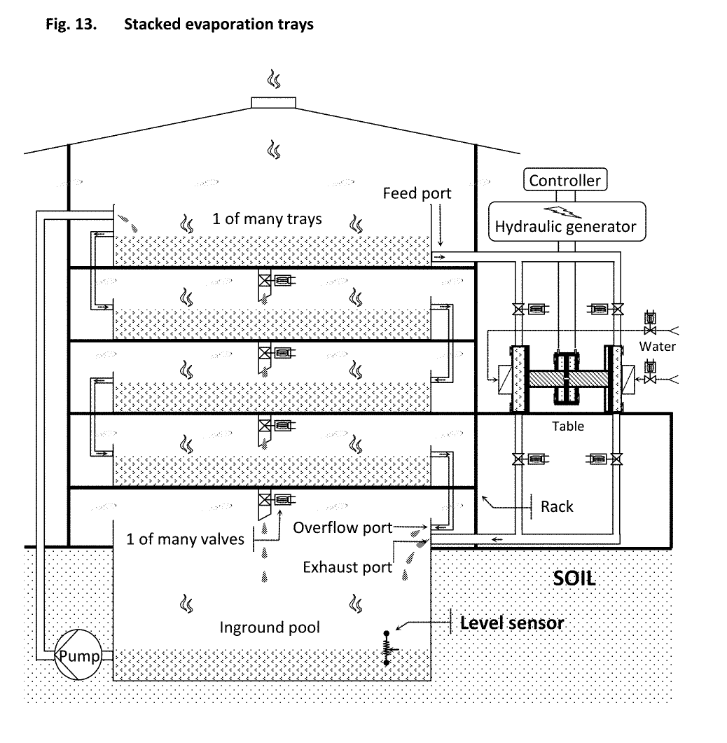

### Description on FIG. 13

FIG. 13 shows the alternative pool configuration that is purposed for those windy districts to cubically maximize the utilization of winds energy as well as to occupy less land.

It features a stacked matrix of evaporation trays over a pool. In this figure, only 4 layers are drawn, but the real choice for an individual project can be any number of layers.

A sturdy rack structure with a plurality of layers is needed to hold all raised and connected trays. The plumbing connection can enable every single tray to hold same height of liquid, and automatically equalize all trays.

The pool depth should be mildly deeper than regular pools discussed in previous description, because it needs to hold the full volume of solution in case of emptying all trays. Because the bottom pool can retract all solution, thus the roof is dispensable, but the tray catchment should be diverted away with reasonable distance, though the divert pipe is not drawn.

There is a drainage short pipe underneath every layer, and it is governed by an electromagnetic valve, so as to empty any or all layers in occasion of maintenance, or to remix entire solution if there is significant discrepancy of concentration in different layers caused by the unequal evaporation rate during relative long time operation.

Generally speaking, evaporation rate on the top layer may be mildly larger than the rest trays, because top layer can always receive more solar sunshine. If winds effect dominates, the small discrepancy could be ignored, otherwise, remixing may be needed after a critical point reached.

The method to remix is: drain all trays to empty, and then turn off all drainage valves, pump liquid from the pool to the tray on top layer, until all trays reach same height, turn off the pump.

A level sensor can be installed in the pool, so as to judge whether a remix job done. The marked sensor can also detect the liquid fall from the marked overflow port in this figure, because liquid will flow out of the port if all trays are full.

A properly timed periodic pump job can almost get equivalent effect to a full remixing process, because it circulates the solution and results in mix effect in some extent, though not perfect.

With this pool and the stacked trays, the afore-preferred wet unit can no longer have to be submersible, as the concentration in pool may be lower than the top tray because of less sunshine, but in order to let it stay dry, the following modifications must be done: i. Open both feed port and exhaust port in all solution compartments; ii. Govern all new added ports by new added electromagnetic valves; iii. Connect feed ports to the top tray, and exhaust ports to the pool; iv. Deploy the unit on a table with about half height of the rack of trays, so as to utilize gravity for both recharging fresh solution and discharging exhaust solution; v. Adjust the program code to manage all new added valves, the remix pump and the level sensor.

It is also possible to still keep the osmosis unit submersible, but the remix process should be run frequently, so as to overcome the disadvantage of diluter solution at the lowest position, in turn, the system will consume extra energy. This situation is not drawn in the figure.

In fact, even with the regular pool without the overhead trays, it is also feasible to change the so-called wet unit for dry stay, as long as there is no problem to spend more money in new added valves and pumps.

Because minor leakage from the rim of solution-faced piston is allowable and tolerable as an engineering trade-off, therefore, if the osmosis-hydraulic pressure transformer unit is exposed in atmosphere, the ugly leakage may be an eyesore, and a dripping catch pan is better placed under the unit if the user cares, then the caught solution can be diverted to the pool. This optional gadget pan is also not drawn in this figure. Of course, for the submersible unit, this is never an issue, because the minor leakage is invisible.

As to the solution depth in each tray, it depends on the local diurnal temperature, the higher the temperature, the shallower the solution can be.

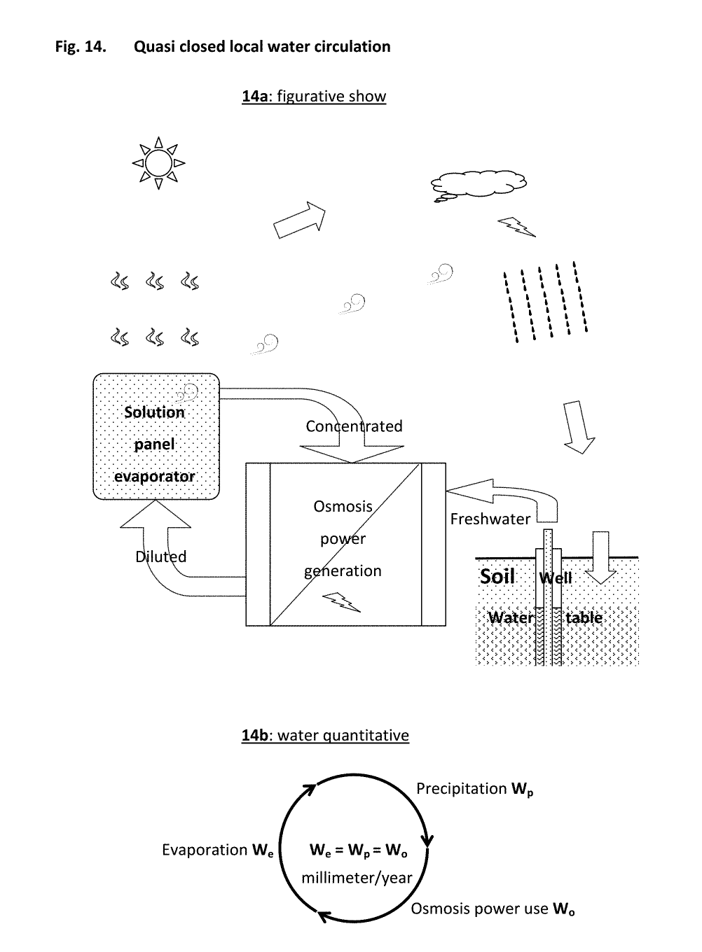

### Description on FIG. 14

FIG. 14 illustrates the quasi closed local water circulation. It contains only 2 sub-figures. Presented by courtesy, this figure is just a bonus to incent peers better understanding subject inventions. Even without this figure, the detail description is still complete.

In sub-figure 14a, a closed water circulation shows how the natural evaporation-precipitation endless cycle is used as “smuggling vehicle” for osmosis energy harvest with subject inventions.

The salt water panel or pool serves the osmosis power generator with naturally concentrated solution, and simultaneously serves as a dump site for exhaust solution of the same generator.

The soil serves as a tremendous precipitation buffer for receiving, seeping and drawing.

The solar and wind energy fuels the evaporation, as well as the “atmosphere heat engine” serves as a condenser for precipitation.

In sub-figure 14b, a proportionally segmented circle suggests the best practice to maintain a quantitative balance: evaporated water =precipitated water =osmosis used water, when taking advantage of water circulation for osmosis power generation.

Of course, it is not mandatory for all PRO applications with subject inventions, as even the Great Nature cannot guarantee the equality of evaporation and precipitation at some local zones. Letting osmosis water usage match local precipitation may be realistic for those wells water users, but those riverside users or tap water users can surely plan whatever project size as long as they have abundant disposable land for solution evaporation.

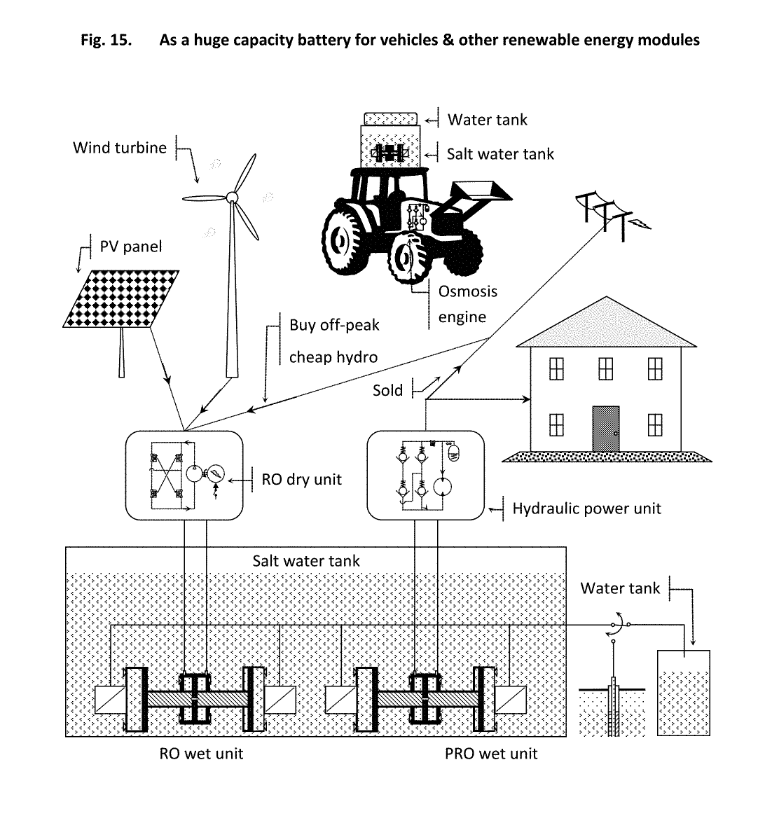

### Description on FIG. 15

FIG. 15 illustrates a masterplan to use the osmosis-hydraulic system as a huge capacity battery for vehicles and storage device for other renewable energy sources.

It no longer allocates land lot for evaporation pool, but for the photovoltaic panel array, so as to take advantage that the PV panels can output more power than the “salt panel” per unit land usage, despite the cost will increase significant percentage.

Instead of a large surface pool, large volume tanks are used, and tank's surface area can be minimized if wish by proper geometry design, because of no longer natural evaporation.

During shiny days, the PV panels output hard to drive electric motor for reverse osmosis. The conventional expensive DC-AC inverter can be eliminated for cost saving, as a DC motor is more convenient to drive the hydraulic pump and the oil current DC-AC fluid inverter that is packed in the so-labeled “RO dry unit”, in turn, the dry unit drives the so-labeled “RO wet unit” that is submerged in the salt water tank, so as to concentrate the solution by reverse osmosis and feedback water into well or dedicated freshwater tank if a well unavailable. There is a sign of switch in the figure for indication of water supply router choice.

During windy days, a wind turbine can also output electricity, and in a joint RO effort, it behaves similar to the PV panels in next series of actions.

During those times that are cloudy or night or windless, the hydro grid can be a RO helper, as long as the cheap off-peak price is enabled.

The PV and wind powers are given with the highest priority, the least for the hydro grid, so as to maximize the green energy utilization for RO recharging the osmosis battery system.

As to the consumer side, the energy in the battery can either be used online by its owner, or sold to the hydro grid during peak demand time for good profit. There are 2 ways for using the energy in situ, one is send into house for appliances, the other is used as backup special fuels to accommodate the demand of mobile machines with osmosis engines, such as those special built tractors, forklifts, etc.

Future tractors or the likes can be equipped with pure osmosis batteries. Those machines usually run in short range shuttle, and easy return for refueling, thus the demerit of low energy density can be avoided. Hybrid power of osmosis plus diesel engine is also possible.

Not like the daylong recharge for an electric vehicle, the refueling moment is very short, just simply dump the exhaust solution to the solution tank, wait a moment, then pump from the same dump point to refill the machine, or if pump from another far point of the same tank, there is no need to wait for diffusion, just immediately refill after dump.

To make sure the refilled solution concentration high enough, the volume of the stationary battery tank should be far greater enough than the tank of mobile equipment, otherwise the exhaust solution may significantly dilute the stock solution.

While refilling, do not forget the water tank, and it is too simple to worth a mention.

To adapt the household appliances, the output electricity should comply with local hydro standard for correct voltage and frequency. If let the hydraulic motor drive a DC generator, then it will be troublesome, because a DC-AC inverter has to be inserted, therefore, as a best practice, a standard AC generator is recommended to be coupled with the hydraulic motor.

To maintain electricity quality, the fluctuation of osmotic pressure is better controlled fewer than 10%, therefore float RO charging the battery is preferred, otherwise, an electronic conditioning or stabilizing module should be used, and this may also be required by hydro companies for feeding into their grid network.

In the figure, a function block is labeled as hydraulic power unit, and it comprises a hydraulic accumulator, a hydraulic motor, an AC electricity generator and a set of 4 hydraulic check valves that function as oil current rectifier. The input of the fluid rectifier is hosed to the so-labeled “PRO wet unit” that is submersed and shares the water supply with RO wet unit.

Because of the design without evaporation, thus theoretically, both water and the salt or other solute are conservative, though casual small replenish may be needed.

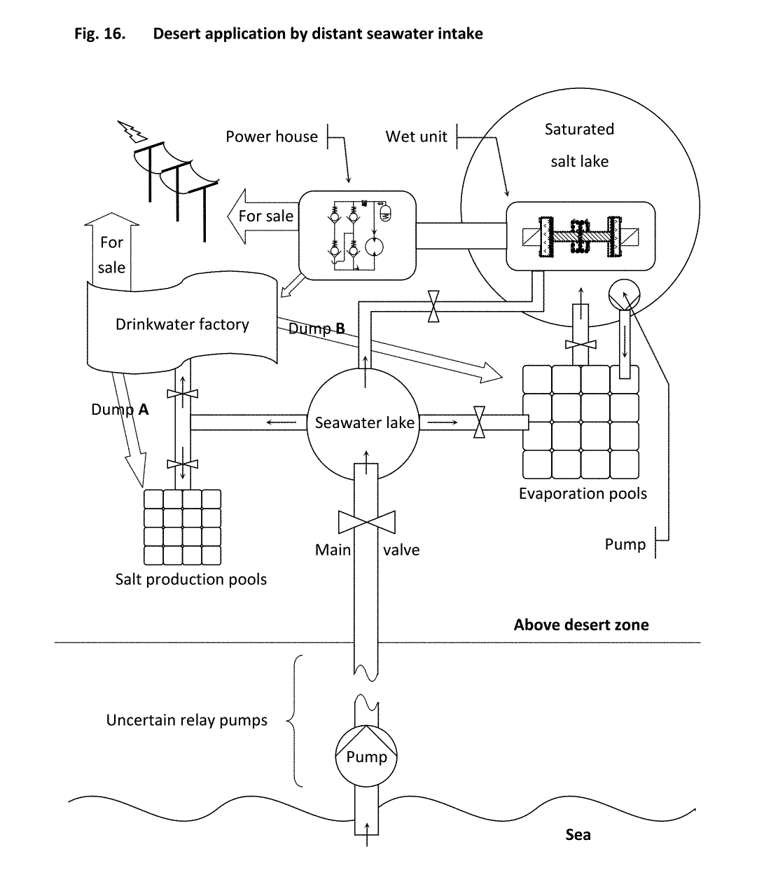

### Description on FIG. 16

FIG. 16 illustrates how to deploy the osmosis power plant in desert area, as well as gradually change it into a wonderful oasis. The sea salt production is reserved as a supplement.

The drawn pumps are key samples, yet there are more undrawn pumps installed in those midway relay stations along the transportation pipeline. Also, the drawn 6 valves are inlined at key points for control and management, but not limited to, more valves may need if necessary.

The incoming seawater firstly fills in the so-labeled “seawater lake” via the main valve. There are 3 outlets around the seawater lake: one is to fill the evaporation pools for making saturated salt solution, next is to fill the reserved pools for sea salt grain production together with the RO freshwater production line, and the last is to fill the osmosis partition of the submersible unit.

After the concentration in the evaporation pools reaches the max, discharge to the so-labeled “saturated salt lake” for storage and PRO power generation, then refill for next saturating cycle.

During power generation, the concentration in the saturated salt lake will be slowly diluted, and the restless evaporation on the lake is supposed to anti-dilute until equilibrium. If the lake evaporation is not enough, the submersible pump should send solution back to the pools.

The interface hydraulic hoses of the wet unit are deployed to connect the onshore dry unit that is labeled as “power house”, and then hydraulic power is converted into electricity. As a great powerplant, most energy are transmitted to outside customers via hydro grid network, minor energy is consumed onsite.

The major onsite energy consumer is the RO freshwater production line, and Its 2 dump paths are labeled as “dump A” and “dump B”, choices are case dependent.

This drawing is just for illustrative purpose, not for accurate dimension scale, and the square count of any pool cluster is only symbolical, not real number.

### REFERENCE

1. Energy production at the Dead Sea by pressure-retarded osmosis: challenge or chimera? By Sidney Loeb, Desalination 120 (1998) 247-262, DOI: 10.1016/S0011-9164(98)00222-7
2. Method and apparatus for generating power utilizing pressure-retarded-osmosis, U.S. Pat. No. 5,390,6250
3. Semi-permeable membrane for use in osmosis and method and plant for providing elevated pressure by osmosis to create power, U.S. Pat. No. 7,566,402 B2
4. Hybrid RO/PRO system, U57871522 B2
5. Osmotic energy, U.S. Pat. No. 8,099,958 B2
6. Utility scale osmotic grid storage, U.S. Pat. No. 8,795,525 B2
7. Method and apparatus for osmotic power generation, U.S. Pat. No. 9,023,210 B2
8. Osmosis battery & high magnetic field generator & superconducting ionic current loop, U.S. 15848097

All inventions herein contain key implementing methods and preferred embodiments, and may be flexibly embodied in other specific forms or consisted of different geometry or other configurations without departing from its spirit or essential characteristics.

To succinctly express claims, hereby repeat the most useful 2 abbreviations: DC—Direct Current, i.e. nonreturnable motion and AC—Alternating Current, i.e. returnable motion, both DC & AC can generally characterize anyone of electrons stream or ions stream or neutral fluid (e.g. aqueous solution, hydraulic oil, even solid or gas) stream, and the solid stream is identical to solid motion, such as shaft or rod motion. Rotational & reciprocal motions are regarded as AC.

Osmosis or reverse osmosis involves respectively mixture or separation process of two liquids with concentration differential. The low concentration liquid can be just water, but not limited to; for convenience, the counterpart high concentration liquid refers to the working solution.

Although above text in this page are not numbered or itemized, the legal effect does hold on par with all the rest numbered claims.

1. A method of osmosis energy restoration that comprises three linked energy conversion steps or processes: forward osmosis DC to hydraulic oil AC, oil AC to oil DC, oil DC to shaft AC, and the optional shaft AC to electrons AC or DC can be attached to previous main link as last conversion. Execution of this method will output energy, and it will result in gradual dilution of the working solution until inacceptable preset threshold reaches.

2. A derivative method from osmosis energy storage that is equal to the reverse processes of claim 1 method. Execution of this method needs energy input, and it will result in gradual concentration of the working solution until saturation status reaches.

3. The apparatus that is implemented with the claim 1 method combining optionally the reverse of claim 1 method, and that can usually be embodied in a system with any one selection or the preferred combination from following application spectra: solar-via-osmosis power generation, mobile osmosis engine, osmosis starter battery for vehicles, yard synergy-osmosis power system, commercial hydro energy and renewable energy to osmosis energy storage, desert to oasis long time remediation with seawater intake solar-via-osmosis powerplant and parasitic freshwater factory, and so on.

4. In addition to the claim 3, if the optional reverse processes of claim 1 method is not used or only used speculatively or occasionally for concentrating the working solution by reverse osmosis with the outsourced renewable intermittent energy or with non-peak low priced hydro-grid energy as an advantage-taking strategy, then a solar evaporation panel or pool or lake or whatever equivalence must exist, and its surface is intentionally designed as large as possible and feasible so as to maximally absorb the solar energy or ambient heat for evaporation that renders equivalent effect with the reverse osmosis method. Any additional practice with good common sense can be applied above evaporation surface to prevent solution from dilution caused by non-ideal weather.

5. In addition to all claims, hydraulic oil and aqueous solution are isolated in separate cylinder compartments, and an electric module governs data acquisition, valves/switches control, etc.
